(19) United States
(12) Patent Application Publication
(10) Pub. No.: US 2007/0148384 A1
(43) Pub. Date: Jun. 28, 2007

(54) Processes for filming biodegradable or compostable containers

(76) Inventors: Joe A. Bowden, Durango, CO (US); Christine C. Johnston, Durango, CO (US)

Correspondence Address: KING & SPALDING LLP, 1180 PEACHTREE STREET, ATLANTA, GA, 30309-3521, US

(21) Appl. No.: 11/605,169

(22) Filed: Nov. 28, 2006

Related U.S. Application Data
(60) Provisional application No. 60/740,149, filed on Nov. 28, 2005.

(51) Int. Cl. B32B 27/08

(52) U.S. Cl. 428/35.7

(57) ABSTRACT

This present invention relates to methods for filming biodegradable or compostable containers, and as well as the containers formed by such methods. In particular, the invention relates to methods for filming biodegradable or compostable containers that can hold hot beverages and foods.

### PRIORITY CLAIM

The present application claims priority to U.S. Provisional Patent Application No. 60/740,149, filed Nov. 28, 2005.

### FIELD OF THE INVENTION

This present invention relates to methods for filming biodegradable or compostable containers, and as well as the containers formed by such methods. In particular, the invention relates to methods for filming biodegradable or compostable containers that can hold hot beverages and foods.

### BACKGROUND OF THE INVENTION

Materials such as paper, paperboard, plastic, polystyrene, and even metals are presently used in enormous quantity in the manufacture of articles such as containers, separators, dividers, lids, tops, cans, and other packaging materials. Modern processing and packaging technology allows a wide range of liquid and solid goods to be stored, packaged, and shipped in packaging materials while being protected from harmful elements, such as gases, moisture, light, microorganisms, vermin, physical shock, crushing forces, vibration, leaking, or spilling. Many of these materials are characterized as being disposable, but actually have little, if any, functional biodegradability. For many of these products, the time for degradation in the environment can span decades or even centuries.

Each year, over 100 billion aluminum cans, billions of glass bottles, and thousands of tons of paper and plastic are used in storing and dispensing soft drinks, juices, processed foods, grains, beer and other products. In the United States alone, approximately 5.5 million tons of paper is consumed each year in packaging materials, which represents only about 15% of the total annual domestic paper production.

Packaging materials (e.g., paper, paperboard, plastic, polystyrene, glass, or metal) are all, to varying extents, damaging to the environment. For example, the manufacture of polystyrene products involves the use of a variety of hazardous chemicals and starting materials, such as benzene (a known mutagen and a probable carcinogen). Chlorofluorocarbons (or “CFCs”) have also been used in the manufacture of “blown” or “expanded” polystyrene products. CFCs have been linked to the destruction of the ozone layer.

Due to widespread environmental concerns, there has been significant pressure on companies to discontinue the use of polystyrene products in favor of more environmentally safe materials. Some groups have favored the use of products such as paper or other products made from wood pulp. However, there remain drawbacks to the sole use of paper due to the tremendous amount of energy that is required to produce it. A strong need to find new, easily degradable materials that meet necessary performance standards remains.

Degradability is a relative term. Some products which appear to be degraded merely break apart into very small pieces. These pieces are hard to see, but can still take decades or centuries to actually break down. Other products are made from materials which undergo a more rapid breakdown than non-biodegradable products. A product is considered compostable if the speed of this degradation is such that the product will degrade within a period of less than approximately 24 days under normal environmental conditions. Achievement of products made of compostable materials which also meet a variety of needs, such as containers for products in a damp or wet condition, has posed a significant challenge.

One solution has been to make packaging materials out of baked, edible sheets, e.g., waffles or pancakes made from a mixture of water, flour and a rising agent. Although edible sheets can be made into trays, cones, and cups which are easily decomposed, they pose a number of limitations. For example, since fats or oils are added to the mixture to permit removal of the sheet from the baking mold, oxidation of these fats cause the edible sheets to go rancid. In general, edible sheets are very brittle and too fragile to replace most articles made from conventional materials. They are also overly sensitive to moisture and can easily mold or decompose prior to or during their intended use.

Starch is a plentiful, inexpensive and renewable material that is found in a large variety of plant sources, such as grains, tubers, and fruits. Starch is frequently discarded as an unwanted byproduct of food processing. Starch is readily biodegradable and does not persist in the environment for a significant period after disposal. Starch is also a nutrient, which facilitates its breakdown and elimination from the environment.

Due to the biodegradable nature of starch, there have been many attempts to incorporate it into a variety of materials. Starch has been incorporated into multi-component compositions in various forms, including as filler and binder, as has been used as a constituent within thermoplastic polymer blends.

PCT Publication No. WO 03/059756 (published Jul. 24, 2003), and corresponding U.S. Pat. Nos. 6,878,199 and 7,083,673 to New Ice Limited, discloses methods for preparing biodegradable or compostable containers produced through the use of a pre-gelled starch suspension that is unique in its ability to form hydrated gels and to maintain this gel structure in the presence of many other types of materials and at low temperatures.

One of the major hindrances for the widespread introduction of starch-based biodegradable or compostable containers into the market place is their inability to contain liquids for any practical length of time. To solve this problem, many types of liquid and/or vapor retaining coating have been tried, including silicates, polyvinyl alcohols, cellulose derivatives, and a number of commercial coatings for paper, waterproof box coatings and waxes.

Many of these items do provide a coating which retains both hot and cold liquids within the container. However, these coatings have other characteristics that make them poor candidates for coating biodegradable or compostable containers. These include residual taste, residual odor, residual color, oil-like films on hot liquids, and with some coatings solvents or carriers are hazardous and high cost. Other constraints include the lack of biodegradable or compostable attributes.

Films have long been used to retain liquids and so are candidates for coating biodegradable and compostable containers. Many films share a common shortcoming: poor adhesion to starch-based biodegradable or compostable substrates. Many of these films adhere to the starch-based surfaces but soon spontaneously delaminate from them. This is unacceptable because there is frequently significant time separating the manufacture and use of a container.

It is therefore an object of the present invention to provide a robust process and materials for the efficient filming of biodegradable container and compostable products.

It is a further object of the present invention to provide methods for filming biodegradable or compostable substrates, including starch-based substrates, to provide enhanced adhesion of the film to the substrate.

It is a still further object of the invention to provide methods for filming biodegradable or compostable substrates useful to hold products at varying temperatures, including high temperatures.

### SUMMARY OF THE INVENTION

The present invention provides an improved methods and materials for filming biodegradable or compostable containers, such as starch-based biodegradable or compostable containers, by applying a heated biodegradable film to a heated container, wherein the temperature of the container is approximately the melt temperature of the film. The heating of the container prior to the application of the film provides improved results by improving the attachment of the film to the container. Also provided are containers made by the processes disclosed herein.

In particular, the present invention provides a method for filming a biodegradable or compostable container which is suitable for holding hot foods or beverages.

Any suitable method can be used to film the biodegradable or compostable containers. In one embodiment, the film is a liquid and can be applied, for example, by spray coating, dip coating or painting the film onto the surface of the container. In another embodiment, the film is a solid and can be applied, for example, by a vacuum.

A heated biodegradable or compostable container is provided, wherein the temperature of the heated container is approximately the melt temperature of the film. The melt temperature of the film may vary, and for example, may range from about 50 to about 200° C. In one embodiment, the melt temperature of the film is higher than the boiling point of substance to be held in the container. For example, the melt temperature of the film is higher than the boiling point of water, i.e., 120° C. For example, the melt temperature of the film may be about 120 to about 190, or from about 145-170° C. The suitable temperature may be selected based on the container and film used. In one embodiment, the heated container is within about 5, 10, 20 or 30° C. of the melt temperature of the film. In particular, the heated container is within about 10° C. of the melt temperature of the film.

Examples of suitable films include biodegradable or compostable films with a melt temperature of about 120 to about 190° C. or more. The films may be, for example, a polyester, polyolefin, polyacetic acid, polyethylene or copolymers thereof. In particular, the film may be biodegradable, aliphatic aromatic copolyester, such as BASF Ecoflex®, having a melt temperature of about 145 to about 170° C.

Any biodegradable or compostable container can be filmed according to the present invention. Suitable biodegradable or compostable containers include, for example, starch-based containers. In particular embodiments, starch-based containers can be formed from pre-gelled starch suspensions maintained at low temperatures, as described below and in PCT Publication No. WO 03/059756 (published Jul. 24, 2003) and corresponding U.S. Pat. Nos. 6,878,199 and 7,083,673 to New Ice Limited, can be filmed according to the present invention.

In one embodiment, the biodegradable or compostable container filmed according to the present invention is produced by a process involving (i) forming a pre-gelled paper starch suspension from approximately 5 to 10% paper pulp by weight of the pre-gel, approximately 5 to 15%, starch, and approximately 75 to 90% water by weight of the pre-gel that is maintained at temperatures between 0 to 60° C.; (ii) adding to the pre-gelled starch suspension a dry or damp, homogeneous mixture comprising one or more native starches to form a homogenous moldable composition; and (iii) molding the homogenous moldable composition with heat to form a biodegradable material.

In another embodiment, the biodegradable or compostable container to be filmed according to the present invention is produced by (i) forming a pre-gelled paper starch suspension, the “pre-gel”, that is maintained at temperatures between 0 to 60° C.; (ii) adding to the pre-gelled paper starch suspension a dry or damp, homogeneous mixture containing at least wood fiber, or wood flour having an aspect ratio between approximately 1:2 and 1:8 to form a homogeneous moldable composition; and (iii) molding the homogeneous moldable composition with heat to form a biodegradable material.

In yet another embodiment, the biodegradable or compostable container to be filmed according to the present invention is produced by (i) forming a pre-gelled cellulose paper-modified starch suspension, the “pre-gel”, that is maintained at temperatures between 0-60° C.; (ii) adding to the pre-gel a dry or damp, homogeneous mixture containing at least wood fiber, or wood flour having an aspect ratio between approximately 1:2 and 1:8 to form a homogeneous moldable composition; and (iii) molding the homogeneous moldable composition with heat to form a biodegradable material. In particular, the pre-gelled cellulose-modified starch suspension includes virgin cellulose pulp and waxy potato starch.

### DETAILED DESCRIPTION OF THE INVENTION

The present invention provides improved methods for filming biodegradable or compostable containers by applying a heated biodegradable film to a heated biodegradable or compostable container, wherein the temperature of the container is approximately the melt temperature of the biodegradable film. It has been shown that the heating of the container prior to the application of the biodegradable film improves the attachment of the film to the container, solving a problem known in the art particular as it relates to starch-based biodegradable or compostable containers.

The present invention also extends to the biodegradable or compostable containers made by the processes disclosed herein.

In particular, the present invention provides a method for filming a biodegradable or compostable container which is suitable for holding heated contents, such as hot foods or beverages.

Any suitable method can be used to film the biodegradable or compostable containers. In one embodiment, the film is a liquid and can be applied, for example, by spray coating, dip coating or painting the film onto the surface of the container. In another embodiment, the film is a solid and can be applied, for example, by a vacuum.

A heated biodegradable or compostable container is provided, wherein the temperature of the heated container is approximately the melt temperature of the film. The melt temperature of the film may vary, and for example, may range from about 50 to about 200° C. In one embodiment, the melt temperature of the film is higher than the boiling point of substance to be held in the container. For example, the melt temperature of the film is higher than the boiling point of water, i.e., 120° C. For example, the melt temperature of the film may be about 120 to about 190 or from about 145-170° C. The suitable temperature may be selected based on the container and film used. In one embodiment, the heated container is within about 5, 10, 20 or 30° C. of the melt temperature of the film. In particular, the heated container is within about 10° C. of the melt temperature of the film.

Examples of suitable films include biodegradable or compostable films with a: melt temperature of about 120 to about 190° C. or more. The films may be, for example, a polyester, polyolefin, polyacetic acid, polyethylene or copolymers thereof. In particular, the film may be biodegradable, aliphatic aromatic copolyester, such as BASF Ecoflex®, having a melt temperature of about 145 to about 170° C.

Any biodegradable or compostable container can be filmed according to the present invention. Suitable biodegradable or compostable containers include, for example, starch-based containers. In particular embodiments, starch-based containers that are formed from pre-gelled starch suspensions that are maintained at low temperatures, as described below and in PCT Publication No. WO 03/059756 (published Jul. 24, 2003) and corresponding U.S. Pat. Nos. 6,878,199 and 7,083,673 to New Ice Limited, can be filmed according to the present invention.

In one embodiment, the biodegradable or compostable container filmed according to the present invention is produced by a process involving (i) forming a pre-gelled paper starch suspension from approximately 5 to 10% paper pulp by weight of the pre-gel, approximately 5 to 15%, starch, and approximately 75 to 90% water by weight of the pre-gel that is maintained at temperatures between 0 to 60° C.; (ii) adding to the pre-gelled starch suspension a dry or damp, homogeneous mixture comprising one or more native starches to form a homogenous moldable composition; and (iii) molding the homogenous moldable composition with heat to form a biodegradable material.

In another embodiment, the biodegradable or compostable container to be filmed according to the present invention is produced by (i) forming a pre-gelled paper starch suspension, the “pre-gel”, that is maintained at temperatures between 0 to 60° C.; (ii) adding to the pre-gelled paper starch suspension a dry or damp, homogeneous mixture containing at least wood fiber, or wood flour having an aspect ratio between approximately 1:2 and 1:8 to form a homogeneous moldable composition; and (iii) molding the homogeneous moldable composition with heat to form a biodegradable material.

In yet another embodiment, the biodegradable or compostable container to be filmed according to the present invention is produced by (i) forming a pre-gelled cellulose paper-modified starch suspension, the “pre-gel”, that is maintained at temperatures between 0-60° C.; (ii) adding to the pre-gel a dry or damp, homogeneous mixture containing at least wood fiber, or wood flour having an aspect ratio between approximately 1:2 and 1:8 to form a homogeneous moldable composition; and (iii) molding the homogeneous moldable composition with heat to form a biodegradable material. In particular, the pre-gelled cellulose-modified starch suspension includes virgin cellulose pulp and waxy potato starch.

Definitions

The term “molded article” shall refer to articles that are shaped directly or indirectly from compositions, such as starch-based compositions, using any molding method known in the art.

The term “container” as used herein is intended to include any article, receptacle, or vessel utilized for storing, dispensing, packaging, portioning, or shipping various types of products or objects (including, but not limited to, food and beverage products). Specific examples of such containers include, among others, boxes, cups, “clam shells,” jars, bottles, plates, bowls, trays, cartons, cases, crates, cereal boxes, frozen food boxes, milk cartons, bags, sacks, carriers for beverage containers, dishes, egg cartons, lids, straws, envelopes, or other types of holders. In addition to integrally formed containers, containment products used in conjunction with containers are also intended to be included within the definition “container”. Such articles include, for example, lids, liners, straws, partitions, wrappers, cushioning materials, utensils, and any other product used in packaging, storing, shipping, portioning, serving, or dispensing an object within a container.

As used herein, the term “dry or damp” refers to a solid composition that can be dry, or can be moist or wetted, generally with water, although other solvents may be used. The amount of liquid in the composition is not sufficient to act as a carrier between particles in the composition.

As used herein, the term “homogeneous mixture” refers to mixtures of solid particulates, solids in a liquid carrier, liquids or suspensions which are substantially uniform in composition on a macroscopic scale. It will be appreciated that mixtures of different types of solid particles or of solids in a liquid carrier are not homogeneous when viewed on a microscopic scale, i.e., as the particle size level.

Containers

A variety of containers can be filmed according to the present invention, including biodegradable or compostable containers, and more particularly starch-based biodegradable or compostable containers. Non-limiting, representative examples of starch-based biodegradable or compostable containers include those described in PCT WO 03/059756, and U.S. Pat. No. 6,878,199, the disclosures of which are incorporated herein by reference.

In one embodiment, the container to be filmed according to the present invention is formed by a method including:

(a) forming a pre-gelled starch suspension that is maintained at low temperatures, for example, between 0-60° C., preferably between 0-40° C.;

(b) adding to the pre-gelled starch suspension a dry or damp, homogeneous mixture containing at least wood fibers having an aspect ratio between approximately 1:2 and 1:8 (width:length) to form a homogenous moldable composition; and

(c) molding the homogenous moldable composition with heat to form a biodegradable container.

In another embodiment, the container to be filmed according to the present invention is formed by a process comprising:

(a) forming a first pre-gelled starch suspension that is maintained at a low temperature, for example, preferably 0-60° C., most preferably between 0-40° C.;

(b) mixing together wood fibers or flour (having an aspect ratio between approximately 1:2 and 1:8), a second pre-gelled starch suspension, and/or a native starch to form a homogenous mixture;

(c) adding to the pre-gelled starch suspension the dry or damp, homogeneous mixture to form a homogenous moldable composition; and

(d) molding the homogenous moldable composition with heat to form a biodegradable container.

In another embodiment, the container to be filmed according to the present invention is formed by a process involving:

(a) forming a first pre-gelled starch suspension that is maintained at a low temperature, for example, preferably 0-60° C., most preferably between 0-40° C.;

(b) mixing together wood fibers or flour (having an aspect ratio between approximately 1:2 and 1:8), a second pre-gelled starch suspension, and/or a native starch to form a homogenous mixture;

(c) adding to the pre-gelled starch suspension the dry or damp, homogeneous mixture to form a homogenous moldable composition;

(d) molding the homogenous moldable composition with heat to form a biodegradable container.

In a specific embodiment, the container to be filmed according to the present invention is formed by a process involving:

(a) forming a pre-gelled starch suspension (the pre-gel) produced from approximately 3-10% potato starch by weight of the pre-gel and approximately 90-97% water by weight of the pre-gel such that the pre-gelled suspension is maintained at low temperatures, for example, preferably 0-60° C., most preferably between 0-40° C.;

(b) mixing together wood fibers or flour (having an aspect ratio between approximately 1:2 and 1:8), a pre-gelled starch suspension produced from approximately 15% corn starch (by weight of the pre-gel) and approximately 85% water by weight of the pre-gel, and a native starch (for example approximately 50-70%, or, more specifically, 57-65.8%, corn starch (by weight of the homogenous moldable composition) or approximately 2-15% or, more specifically, 3-5% potato starch (by weight of the homogenous moldable composition)) to form a homogeneous mixture;

(c) adding to the pre-gelled potato starch suspension the homogeneous mixture to form a final homogenous moldable composition; and

(d) molding the homogenous moldable composition with heat to form a biodegradable container.

In another embodiment, the container to be filmed according to the present invention is formed by a process involving:

(a) forming a pre-gelled paper starch suspension that is maintained at low temperatures, for example, between 0-60° C., preferably between 0-40° C.;

(b) adding to the pre-gelled paper starch suspension a dry or damp, homogeneous mixture containing at least wood fibers having an aspect ratio between approximately 1:2 and 1:8 (width:length) to form a homogeneous moldable composition; and

(c) molding the homogeneous moldable composition with heat to form a biodegradable container.

In other embodiments, the container to be filmed according to the present invention is formed by a process involving:

(a) forming a first pre-gelled paper starch suspension that is maintained at low temperatures, for example, between 0-60° C., preferably between 0-40° C.;

(b) mixing together wood fibers or flour (having an aspect ratio between approximately 1:2 and 1:8), and a native starch(s) to form a homogeneous mixture;

(c) adding to the first pre-gelled starch suspension the homogenous mixture to form a homogenous moldable composition; and

(d) molding the homogenous moldable composition with heat to form a biodegradable container.

In a specific embodiment, the container to be filmed according to the present invention is formed by a process involving:

(a) forming a pre-gelled starch suspension produced from approximately 2-15% potato starch (by weight of the pre-gel), preferably about 2.5, 5, 10, or 15%; approximately 5-10% paper pulp (by weight of the pre-gel), preferably about 5.9-8%; and approximately 75-95% water (by weight of the pre-gel) such that the pre-gelled suspension is maintained at low temperatures, for example, between 0-60° C., preferably between 0-40° C.;

(b) mixing together wood fibers or flour (having an aspect ratio between approximately 1:2 and 1:8, preferably between 1:2 and 1:4), native corn starch and native potato starch to form a homogeneous mixture;

(c) adding to the pre-gelled potato starch suspension the homogeneous mixture to form a homogenous moldable composition; and

(d) molding the homogenous moldable composition with heat to form a biodegradable container.

In other embodiments, the following materials can be added to the wood fibers to form a homogeneous mixture:

(i) waxes, fatty alcohols, phospholipids or other high molecular weight biochemicals, such as glycerol, for example between approximately 1-5% or, more specifically, 2.6-3.7% glycerol (by weight of the homogenous moldable composition);

(ii) approximately 0.5-20% water (by weight of the homogenous moldable composition), preferably about 0.5-10%, 0.5-11% 0.5-12%, 10 or 20%;

(iii) baking powder, for example between approximately 0.1-15% by weight of the homogenous moldable composition, preferably about 0.42, 1 or 12%; and/or

(iv) additional materials, such as up to approximately 5% by weight of the homogenous moldable composition of natural earth fillers, for example, clays such as bentonite, amorphous raw products such as gypsum and calcium sulfate, minerals such as limestone, or man made materials such as fly-ash.

In still other embodiments, the container to be filmed according to the present invention can be formed by a process involving:

(a) forming a pre-gelled starch suspension or paper starch suspension that is maintained at a low temperature, for example, preferably from about 0-60° C., most preferably from about 0-40° C.;

(b) mixing together wood fibers or flour (having an aspect ratio between approximately 1:2 and 1:8) and (i) dry or damp starch, such as corn starch; (ii) pre-gelled starch, such as a pre-gelled corn starch produced from approximately 15% corn starch (by weight of the pre-gel) and 85% water; (iii) waxes, fatty alcohols, phospholipids and other high molecular weight biochemicals, such as glycerol, for example between approximately 1-5% glycerol (by weight of the homogenous moldable composition); (iv) approximately 0.5-20% water, preferably about 0.5-10%, 0.5-11% 0.5-12%, 10 or 20% (by weight of the homogenous moldable composition); (v) baking powder, for example between approximately 0.1-15% (by weight of the homogenous moldable composition), preferably 0.42, 1 or 12%; and/or (vi) additional materials, such as up to approximately 5%, 0-4%, 0-13%, 2-13%, or 0-15% by weight of the homogenous moldable composition of natural earth fillers, for example, clays such as bentonite, amorphous raw products such as gypsum and calcium sulfate, minerals such as limestone, and man made materials such as fly-ash to form a homogeneous mixture;

(c) adding to the pre-gelled starch suspension the dry or damp, homogeneous mixture to form a homogenous moldable composition; and

(d) molding the homogenous moldable composition with heat to form a biodegradable container.

In one embodiment, the pre-gelled starch suspension used to form the container filmed by the process of the present invention is produced from approximately 2.5-15% starch (by weight of the pre-gel), such as potato or corn starch, and from approximately 85-97.5% of water by weight of the homogenous moldable composition. In another embodiment, the pre-gelled starch suspension is produced from approximately 2.5-5.5% starch and from approximately 94.5-97.5% water (by weight of the pre-gel). In preferred embodiments, the pre-gelled starch suspension is produced from approximately 2.5-10% potato starch, more preferably 3%, 5%, 7.5% or 10% potato starch, and 90, 92.5, 95 or 97% water (by weight of the pre-gel). In another preferred embodiment, the pre-gelled starch suspension is produced from approximately 15% corn starch (by weight of the pre-gel).

In another embodiment, the pre-gelled starch suspension used to form the container filmed by the process of the present invention is produced from approximately 7-12% waxy potato starch, 7-12% virgin cellulose pulp, and 76-86% water by weight of the homogenous moldable composition. In another embodiment, the pre-gelled starch suspension is produced from approximately 8-11% waxy potato starch, 8-11% virgin cellulose pulp, and 78-84% water by weight of the moldable composition.

In another embodiment, the pre-gelled paper starch solution used to form the container filmed by the process of the present invention is produced from approximately 5-10% paper pulp (by weight of the pre-gel), preferably 5.9-8%, more preferably, 7.3-7.5, 6.5-6.7, or 5.9-6.1%; approximately 5-15%, preferably 10% potato or other natural starch (such as corn starch), and approximately 75-90% water (by weight of the pre-gel).

In one embodiment, the native starch used to form the container filmed by the process of the present invention can be corn starch or potato starch. In another embodiment potato starch and corn starch can be used together. In a further embodiment, the corn starch can comprise approximately 4-18%, preferably from about 4.45-17.9%, or from about 5-35%, preferably about 5.9-34.4% by weight of the homogenous moldable composition, preferably, 4, 5, 6, 13, 15, 16, 17, 18, 20, 21, 22, 26, 28, 29, 30, 31 or 34%.

In a still further embodiment, the wood fibers or flour used to form the container filmed by the process of the present invention can comprise approximately 11-24%, preferably 11, 12, 13, 14, 16, 17, 18, 19, 20, 21, 22, 23, or 23.3% by weight of the homogenous moldable composition that contains the pregelled starch solution. In an alternate embodiment, the wood fibers or flour can comprise approximately 7-11%, preferably 7, 8, 9, 10 or 11%, by weight of the homogenous moldable composition that contains the pregelled paper starch solution. The wood fibers or flour can have an aspect ratio, width to length of between approximately 1:2 and 1:10, 1:2 and 1:9, 1:2 and 1:8, 1:2 and 1:7, 1:2 and 1:6, 1:2 and 1:5, 1:2 and 1:4, 1:2 and 1:3, or a fraction thereof, for example a ratio of between 1:2 and 1:9.9.

In another embodiment, the containers which are filmed according to the present invention are efficiently biodegradable, preferably disintegrating to component parts in less than one year. In another embodiment, the containers are compostable, disintegrating to component molecules in less than six months, preferably in less than approximately 24 days.

In further embodiments, pressure can also be used in combination or alternation with heat to mold the biodegradable container filmed according to the present invention. Any amount of pressure can be used that achieves the desired product, for example, pressure between approximately 2-3 psi may be appropriate. Likewise, any amount of heat may be used that achieves the desired result. For example, in one embodiment, the heat used to mold the biodegradable containers is between approximately 150-250° C., preferably about 195-225° C., most preferably 215° C.

In a further embodiment, a vacuum can be used to form a film around the molded article. When using a vacuum to form a film around the molded article, it is recognized that increasing the levels of wood flour/fiber and/or paper pulp can facilitate the vacuuming process. In one embodiment, the wood flour/fiber and/or paper pulp levels can be increased to 30, 40 or 50% by weight of the final mixture.

In another embodiment, a biodegradable polymer can be applied as a liquid to the surface of a container by dip coating, spray coating or by painting. Optionally, the liquid may be heated prior to applying to the surface of the container.

In another aspect of the present invention, the container filmed according to the present invention is produced by:

(a) preparing a gel which includes a waxy potato starch, cellulose and water;

(b) mixing the gel with dry waxy potato starch; and

(c) placing the mixture into a heated mold and baking at an elevated temperature.

In one embodiment, a corn starch can be mixed with the gel and the dry waxy potato starch. In one embodiment, the mixture can include a lubricant. In another embodiment, the mixture can include a foaming agent.

In another embodiment, the container to be filmed by the present invention is formed by a process including:

(a) forming a paper starch suspension, wherein the paper pulp that is maintained at low temperatures, for example, between 0-60° C., preferably between 0-40° C.; and

(b) molding the homogeneous moldable composition with heat to form a biodegradable container.

In one embodiment, the container filmed according to the present invention is formed by a process involving:

(a) forming a paper starch suspension, wherein the pregelled paper starch solution is produced from up to approximately 50, 60, 75, 85 or 90% virgin cellulose pulp (by weight of the pre-gel) and approximately 5-15%, preferably 10% waxy potato or other natural starch (such as corn starch), and approximately 5-90% water (by weight of the pre-gel), and wherein the paper pulp that is maintained at low temperatures, for example, between 0-60° C., preferably between 0-40° C.; and

(b) molding the homogeneous moldable composition with heat to form a biodegradable container.

In yet another embodiment, the container filmed according to the present invention is formed by a process which includes:

(a) forming a pre-gelled paper starch suspension that is maintained at low temperatures, for example, between 0-60° C., preferably between 0-40° C.;

(b) mixing together (i) 0-24% wood fibers or flour (having an aspect ratio between approximately 1:2 and 1:8) by weight of the homogenous moldable composition; (ii) dry or damp starch, such as corn starch; (iii) pre-gelled starch, such as a pre-gelled corn starch produced from approximately 15% corn starch (by weight of the pre-gel) and 85% water; (iv) waxes, fatty alcohols, phospholipids and other high molecular weight biochemicals, such as glycerol, for example between approximately 1-5% glycerol (by weight of the homogenous moldable composition); (v) approximately 0.5-20% water, preferably about 0.5-10%, 0.5-11% 0.5-12%, 10 or 20% (by weight of the homogenous moldable composition); (vi) baking powder, for example between approximately 0.1-15% (by weight of the homogenous moldable composition), preferably 0.42, 1 or 12%; and/or (vii) additional materials, such as up to approximately 5%, 0-4%, 0-13%, 2-13%, or 0-15% by weight of the homogenous moldable composition of natural earth fillers, for example, clays such as bentonite, amorphous raw products such as gypsum and calcium sulfate, minerals such as limestone, and man made materials such as fly-ash to form a homogeneous mixture;

(c) adding to the pre-gelled starch suspension the dry or damp, homogeneous mixture to form a homogenous moldable composition; and

(d) molding the homogenous moldable composition with heat to form a biodegradable container.

In a further embodiment, the container filmed according to the method of the present invention is formed by a process which includes:

(a) forming a pre-gelled paper starch suspension that is maintained at low temperatures, for example, between 0-60° C., preferably between 0-40° C.;

(b) mixing together (i) 0-24% wood fibers or flour (having an aspect ratio between approximately 1:2 and 1:8) by weight of the homogenous moldable composition; (ii) dry or damp starch, such as corn starch; (iii) pre-gelled starch, such as a pre-gelled corn starch produced from approximately 15% corn starch (by weight of the pre-gel) and 85% water; (iv) waxes, fatty alcohols, phospholipids and other high molecular weight biochemicals, such as glycerol, for example between approximately 1-5% glycerol (by weight of the homogenous moldable composition); (v) approximately 0.5-20% water, preferably about 0.5-10%, 0.5-11% 0.5-12%, 10 or 20% (by weight of the homogenous moldable composition); (vi) baking powder, for example between approximately 0.1-15% (by weight of the homogenous moldable composition), preferably 0.42, 1 or 12%; and/or (vii) additional materials, such as up to approximately 5%, 0-4%, 0-13%, 2-13%, or 0-15% by weight of the homogenous moldable composition of natural earth fillers, for example, clays such as bentonite, amorphous raw products such as gypsum and calcium sulfate, minerals such as limestone, and man made materials such as fly-ash to form a homogeneous mixture;

(c) adding to the pre-gelled starch suspension the dry or damp, homogeneous mixture to form a homogenous moldable composition; and

(d) molding the homogenous moldable composition with heat to form a biodegradable container.

It is recognized that in any embodiment, paper pulp can be substituted for wood fibers/flour.

In another embodiment, the container filmed according to the method of the present invention is an open cell foam container prepared by:

(a) forming a first pre-gelled starch suspension that is maintained at a low temperature, for example, preferably from 0-60° C., most preferably from 0-40° C.; (b) mixing together wood fibers or flour (having an aspect ratio between approximately 1:2 and 1:8), a second pre-gelled starch suspension to form a homogeneous composition, and a source of gas, such as a source of carbon dioxide gas;

(c) adding to the first pre-gelled starch suspension a dry or damp, homogeneous mixture containing the wood fibers and second pre-gelled starch; and

(d) molding the homogeneous composition with heat to form a biodegradable container.

In a specific embodiment, the process for forming an open cell foam container includes:

(a) forming a pre-gelled starch suspension produced from approximately 3-5% potato starch (by weight of the pre-gel) and approximately 95-97% water (by weight of the pre-gel) such that the pre-gelled suspension is maintained at low temperatures, for example, between 0-60° C., preferably between 0-40° C.;

(b) mixing together wood fibers or flour (having an aspect ratio between approximately 1:2 and 1:8), a second pre-gelled starch suspension (the second pre-gel) produced from approximately 15% corn starch (by weight of the second pre-gel) and approximately 85% water (by weight of the second pre-gel), and baking powder, for example between 0.42-12% baking powder (by weight of the homogeneous moldable composition) to form a homogeneous mixture;

(c) adding to the pre-gelled potato starch suspension a homogeneous mixture containing the wood fibers and pre-gelled corn starch to form a homogeneous moldable composition; and

(d) molding the homogeneous moldable composition with heat to form a biodegradable container.

The biodegradable containers filmed according to the present invention include those that are formed from different combinations of materials by weight. For example, containers can be formed from approximately 16-61% pre-gelled potato starch suspension (by weight of the homogenous moldable composition) and approximately 11-37% (or 11-15%) wood fibers or flour (by weight of the homogenous moldable composition). In addition, various combinations of other materials can be added to the wood fibers or flour to produce a homogenous mixture before mixing it with the pre-gelled starch suspension, including, but not limited to:

(i) approximately 57-66% pre-gelled corn starch suspension (by weight of the homogenous moldable composition) (suspension formed from approximately 5-15% corn starch (by weight of the pre-gel) and approximately 85-95% water by weight of the pre-gel);

(ii) approximately 4-35% native starch (by weight of the homogenous moldable composition), for example 3-5% (preferably 3.7% or 4.2%) native potato starch, and/or 15.4-34.4% native corn starch;

(iii) approximately 1-5% glycerol (by weight of the homogenous moldable composition);

(iv) up to approximately 10 or 20% water (by weight of the homogenous moldable composition);

(v) approximately 0.1-15% baking powder (by weight of the homogenous moldable composition);

(vi) less than approximately 5% natural materials (by weight of the homogenous moldable composition), such as bentonite clay.

Pre-Gelled Starch Suspensions

The containers that can be filmed according to the present invention include those formed from pre-gelled starch suspensions. The starch component can include any known starch material, including one or more unmodified starches, modified starches, and starch derivatives. Preferred starches can include most any unmodified starch that is initially in a native state as a granular solid and which will form a thermoplastic melt by mixing and heating. Starch is typically considered a natural carbohydrate chain comprising polymerized glucose molecules in an alpha-(1,4) linkage and is found in nature in the form of granules. Such granules are easily liberated from the plant materials by known processes. Starches used in forming the pre-gelled starch suspension desirably possess the following properties: the ability to form hydrated gels and to maintain this gel structure in the presence of many types of other materials; and the ability to melt into plastic-like materials at low temperatures, for example, between 0-75° C., preferably between 0-65° C., and in the presence of a wide range of materials and in moist environments and to exhibit high binding strengths and produce an open cell structure for both insulation and cross linking of components. The preferred sources of starch for pregels are cereal grains (e.g., corn, waxy corn, wheat, sorghum, rice, and waxy rice, which can also be used in the flour and cracked state), tubers (potato), roots (tapioca (i.e., cassaya and maniac), sweet potato, and arrowroot), modified corn starch, and the pith of the sago palm.

While not intending to be bound to any specific mechanistic explanation for the desirable properties observed, it is believed that the gel property holds other components in suspension until the product can be molded and to hold the moisture levels constant within the mixture until and during molding. The second property is evident in the transition in the mold of the gel structure into a drier and dried form that will then melt into the binding plastic-like product within the confines of the mold. This complex three dimensional cross linked structure is the backbone for the product, exhibiting both strength and insulation properties. The pre-gelled starch is prepared by mixing the starch with water (for example at levels of approximately 2% to 15% starch by weight of the pre-gel, preferably at least 2.5%, 3%, 5%, 10%, or 15%) at about ambient temperature (approximately 25° C.). The gel is formed by slowly heating the water-starch mixture with constant agitation until a gel forms. Continued heating will slowly degrade the gel, so the process should be stopped as soon as an appropriate level of gelation is achieved. Gels can be used cold. The gel is stable for a few days if refrigerated, but preferably the gel is not frozen. For storage a biocide can be added, preferably at a concentration of about 10 to about 500 ppm.

Preferred starch-based binders are those that gelate and produce a high viscosity at a relatively low temperature. For example, potato starch quickly gelates and reaches a maximum viscosity at about 65° C. The viscosity then decreases, reaching a minimum at about 95° C. Wheat starch acts in a similar fashion and can also be used. Such starch-based binders are valuable in producing thin-walled articles having a smooth surface and a skin with sufficient thickness and density to impart the desired mechanical properties.

In general, starch granules are insoluble in cold water; however, if the outer membrane has been broken by, e.g., by grinding, the granules can swell in cold water to form a gel. When the intact granules are treated with warm water, the granules swell and a portion of the soluble starch diffuses through the granule wall to form a paste. In hot water, the granules swell to such an extent that they burst, resulting in gelation of the mixture. The exact temperature at which a starch swells and gelates depends on the type of starch. Gelation is a result of the linear amylose polymers, which are initially compressed within the granules, stretching out and cross-linking with each other and with the amylopectin. After the water is removed, the resulting mesh of inter-connected polymer chains forms a solid material that can have a tensile strength up to about 40-50 MPa. The amylose polymers can also be used to bind individual aggregate particles and fibers within the moldable mixture.

It is possible to reduce the amount of water in starch melts by replacing the water inherently found in starch with an appropriate low volatile plasticizer capable of causing starch to melt below its decomposition temperature, such as glycerin, polyalkylene oxides, mono- and diacetates of glycerin, sorbitol, other sugar alcohols, and citrates. This can allow for improved processability, greater mechanical strength, better dimensional stability over time, and greater ease in blending the starch melt with other polymers.

Water can be removed before processing by using starch that has been pre-dried so as to remove at least a portion of the natural water content. Alternatively, water can be removed during processing by degassing or venting the molten mixture, such as by means of an extruder equipped with venting or degassing means. Native starch can also initially be blended with a small quantity of water and glycerin in order to form starch melts that are subjected to a degassing procedure prior to cooling and solidification in order to remove substantially all of the water therefrom.

In one aspect, the pre-gelled starch suspension is produced from approximately 3-10%, preferably, 3, 5, 7.5 or 10%, starch by weight of the pre-gel, preferably, potato starch, and 90-97% water by weight of the pre-gel such that the pre-gelled suspension is maintained at low temperatures. In one embodiment, the pregeled starch solution can be maintained at all temperatures above freezing, 0° C. In another embodiment, the pregelled starch solution can be maintained for greater that 24 hours, up to a few days, if stored refrigerated, for example, between 3-15° C.

In another aspect, a pre-gelled paper starch suspension is produced from approximately 5-15%, preferably 10%, starch (by weight of the pre-gel), preferably potato starch; 5-10% paper pulp (by weight of the pre-gel), preferably 5.9-8%, more preferably, 7.3-7.5, 6.5-6.7, or 5.9-6.1%; and 75-92.5% water (by weight of the pre-gel), such that the pre-gelled suspension is maintained at low temperatures. In one embodiment, the pregelled paper starch solution can be maintained at all temperatures above freezing, 0° C. In another embodiment, the pregelled paper starch solution can be maintained for greater that 24 hours, up to a few days, if stored refrigerated, for example, between 3-15° C.

Paper Pulp

In one aspect, prepulped cellulose is mixed with the pregel. The preferred amount of cellulose pulp added is in the range of 5-10% by weight of the pre-gel, preferably 5.9-8%, more preferably, 7.3-7.5, 6.5-6.7, or 5.9-6.1%. Preferably, a virgin cellulose pulp is used. The prepulped paper can be mixed with 5-15%, preferably approximately 10% potato or other natural starch (such as corn starch), and 75-90% water, for example, 580 g water, 57.5 g dry potato starch, and 42.31 g paper pulp. Preferably, the starch is a waxy potato starch. The mixture is stirred at slow rpm while increasing the temperature to 60-70° C., after which premixed dry ingredients (wood flour (preferably 5-10% (w/w) with an aspect ratio of 1:8; 1:9.9; 1:9 or 1:5)), native potato starch (preferably 10-15% by weight) and/or native corn starch (preferably 10-20% by weight) can be added.

Paper pulp can be produced by any method known in the art. Paper pulp is a fibrous material produced by mechanically or chemically reducing woody plants into their component parts from which, pulp, paper and paperboard sheets are formed after proper slushing and treatment, or used for dissolving purposes (Lavigne, JR “Pulp & Paper Dictionary” 1993: Miller Freeman Books, San Francisco). Cellulose pulp production is a process that utilizes mainly arboreal species from specialized cultivations. To produce the paper pulp, wood, typically reduced to dimensions of about 30-40 mm and a thickness of about 5-7 mm, is treated at high temperature and pressure with suitable mixes of chemical reagents that selectively attack lignin and hemicellulose macromolecules, rendering them soluble. Pulps coming from this first treatment, commonly called “cooking”, are called “raw pulps”; they still contain partly modified lignin and are more or less Havana-brown colored. Raw pulps can be submitted to further chemical-physical treatments suitable to eliminate almost entire lignin molecules and colored molecules in general; this second operation is commonly referred to as “bleaching”. For this process, rapid growth ligneous plants are mainly used, which, with the help of chemical substances (alkali or acids), in condition of high pressure and temperature, are selectively delignified to obtain pulps containing cellulose and other components of lignocellulose. These pulps can then submitted to mechanical and chemical-physical treatments, in order to complete the removal of lignins and hemicellulose residual components, and utilized thereafter for paper production. This raw cellulose pulp or “virgin” pulp is a higher order or processed word pulp wherein the lignins have been removed, and does not require additional chopping or processing and can be added directly to the mixing means to produce the molding material. Any form of paper pulp can be used in the packaging materials described herein.

Dry or Damp Starch

After formation of a pregel, dry or damp materials can be added (such as fibers, flour, pulp, or dry starches) to produce the final moldable mixture. The dry or damp materials can be pre-mixed before addition to the pregel, to increase the homogeneity of the final product and increase the structural integrity of the final molded product. Preferably, the amount of pregel added to the final mixture is in the range of about 7-60% by weight of the homogenous moldable composition. Preferably, the pregel is about at least 7%, 8%, 9%, 10%, 11%, 12%, 16%, 16.3%, 25%, 33%, 42%, 47%, 54%, 50%, 52%, 55%, 56%, 60% or 60.4% by weight of the homogenous moldable composition.

One component in the dry/damp material that can be added to the pre-gelled starch is a dry or damp starch binder component. This starch can be corn or other dry starch (for example potato, rice or wheat starch). Pre-gelatinized starch-based binders can also be added to the moldable mixture. Pregelatinized starch-based binders are starches that have previously been gelated, dried, and ground back into a powder. Since pre-gelatinized starch-based binders gelate in cold water, such starch-based binders can be added to the moldable mixture to increase the mixture viscosity prior to being heated. The increased viscosity prevents settling and helps produce thicker cell walls. This starch component can be pre-gelled in a manner similar to that describes above. For example, the second starch component can be pregelled in a mixture of between about 1 and 15% starch (for example 15% corn starch) and 85-99% water. In these cases additional dry starch can be added as necessary to the homogeneous mixture to adsorb excess water. If the pregelled second starch is still damp, the preferred amount to be added is in the range of 55-65% by weight of the homogenous moldable composition, most preferably about 57% by weight or about 65% by weight.

The concentration of the native starch binder within the moldable mixtures are preferably in a range of about 5% to about 60% by weight of the homogenous moldable composition, more preferably in a range from about 15% to about 30%, and most preferably about at least 6%, 20%, 21%, 25%, 26%, 27%, 28%, 29%, 30%, 31%, or 34% by weight of the homogenous moldable composition. Furthermore, combinations of different starches can be employed to more carefully control the viscosity of the mixture throughout a range of temperatures, as well as to affect the structural properties of the final hardened article. For example, the mixture can consist of a mixture of dry or damp corn and potato starch (16-44% of corn and potato starch by weight of the homogenous moldable composition), such that the corn starch comprises between about 13-30% by weight, preferably between about 13-18% or 28-30%, and the potato starch comprises between about 3-14%, preferably approximately 11-14% or 3-5% of the final homogenous moldable composition.

Starch is produced in many plants, and many starches may be suitable for use in the present invention, however, as with the starch used in the pre-gel, preferred sources of starches are seeds of cereal grains (e.g., corn, waxy corn, wheat, sorghum, rice, and waxy rice), which can be used in the flour and cracked state. Other sources of starch include tubers (potato), roots (tapioca (i.e., cassaya and maniac), sweet potato, and arrowroot), and the pith of the sago palm. The starch can be selected from natural starch, chemically and/or physically modified starch, biotechnologically produced and/or genetically modified starch and mixtures thereof. Suitable starches can also be selected from the following: ahipa, apio (arracacha), arrowhead (arrowroot, Chinese potato, jicama), baddo, bitter casava, Brazilian arrowroot, casava (yucca), Chinese artichoke (crosne), Japanese artichoke (chorogi), Chinese water chestnut, coco, cocoyam, dasheen, eddo, elephant's ear, girasole, goo, Japanese potato, Jerusalem artichoke (sunroot, girasole), lilly root, ling gaw, malanga (tanier), plantain, sweet potato, mandioca, manioc, Mexican potato, Mexican yam bean, old cocoyam, saa got, sato-imo, seegoo, sunchoke, sunroot, sweet casava, tanier, tannia, tannier, tapioca root, taro, topinambour, water chestnut, water lily root, yam bean, yam, yautia, barley, corn, sorghum, rice, wheat, oats, buckwheat, rye, kamut brand wheat, triticale, spelt, amaranth, black quinoa, hie, millet, plantago seed husks, psyllium seed husks, quinoa flakes, quinoa, teff.

Starches that can be used include unmodified starches (amylose and amylopectin) and modified starches. By modified, it is meant that the starch can be derivatized or modified by typical processes known in the art such as, e.g. esterification, etherification, oxidation, acid hydrolysis, cross-linking, and enzyme conversion. Typical modified starches include esters, such as the acetate and the half-esters of dicarboxylic acids/anhydrides, particularly the alkenylsuccinic acids/anhydrides; ethers, such as the hydroxyethyl and hydroxypropyl starches; oxidized starches, such as those oxidized with hypochlorite; starches reacted with cross-linking agents, such as phosphorus oxychloride, epichlorohydrin, hydrophobic cationic epoxides, and phosphate derivatives prepared by reaction with sodium or potassium orthophosphate or tripolyphosphate, and combinations thereof. Modified starches also include seagel, long-chain alkylstarches, dextrins, amine starches, and dialdehyde starches. Unmodified starch-based binders are generally preferred over modified starch-based binders because they are significantly less expensive and produce comparable articles.

The dry ingredients, such as corn starch and wood flour are preferably pre-mixed into a homogeneous mixture before being added to the pregel. The dry/damp starch and the wood flour or fibers can be mixed to form a homogeneous mixture using any suitable means, such as, for example, a Kitchen Aid® Commercial Mixer.

Wood Flour or Fibers

Additional fibers can be employed as part of the dry/damp material added to the pre-gelled starch. The fibers used are preferably organic, and most preferably cellulose-based materials, which are chemically similar to starches in that they comprise polymerized glucose molecules. “Cellulosic fibers” refers to fibers of any type which contain cellulose or consist of cellulose. Plant fibers preferred here are those of differing lengths typically in the range from 600 micron to 3000 micron, principally from hemp, cotton, plant leaves, sisal, abaca, bagasse, wood (both hard wood or soft wood, examples of which include southern hardwood and southern pine, respectively), or stems, or inorganic fibers made from glass, graphite, silica, ceramic, or metal materials. The cellulosic fibers can include wood fibers and wood flour. In one embodiment, 11-24% by weight of wood fibers or flour is added to the final mixture. In the preferred embodiments, wood fibers or flour comprise about at least 11%, 12%, 13%, 14%, 16%, 17%, and 23.3% by weight of the homogenous moldable composition.

Wood flour and fibers are very much like rough tooth picks that have small barb like structures coming out from the main fiber to participate in the cross linkage process with the cooling starch melt. This property adds both strength and water resistance to the surface produced within the mold. The rapid grinding process to produce flour or short fibers by-passes the expensive and polluting processes that are used to manufacture pulp and paper. The wood flour can be resinous wood flour. Wood flour is a wood by-product commonly used to thicken epoxies to a peanut butter consistency. Preferably, the wood flour is softwood flour, which contains relatively large amounts of resin. Moreover, softwood is used industrially on a large scale, such as in the building trade, with the consequence that an abundance of wood flour from, for instance, saw mills, is available at a low price. Wood flours can be graded based on the mesh size the flour. In general, wood flour having a mesh size of 20-100 is suitable, and an aspect ratio of less than 1:10, preferably less than 1:9, more preferably less than 1:8.

Larger particles are considered to be fibers. The expression “fibers” refers to fine, thin objects restricted in their length, the length being greater than the width. They can be present as individual fibers or as fiber bundles. Such fibers can be produced in a manner known to those skilled in the art. Preferred fibers have a low length to diameter ratio and produce materials of excellent strength and light weight. In one embodiment, the fibers can have an aspect ration of about between 1:2 and 1:10; 1:2 and 1:9.9; 1:2 and 1:9; 1:2 and 1:8; 1:2 and 1:7; 1:2 and 1:6; 1:2 and 1:5; 1:2 and 1:4; or 1:2 and 1:3.

It should also be understood that some fibers, such as southern pine and abaca, have high tear and burst strengths, while others, such as cotton, have lower strength but greater flexibility. In the case where better placement, higher flexibility, and higher tear and burst strength are desired, a combination of fibers having varying aspect ratios and strength properties can be added to the mixture.

In an additional aspect, it is recognized that to decrease the residual odor of the wood in the final product, the amount of paper pulp can be increased to 50%, or 30-50%, by weight of the final mixture, and the amount of wood flour or fiber can be decreased to 0%.

Additional Materials

In addition to the dry/damp starch and the wood flour, the homogenous mixture can also include one or more additional materials depending on desired characteristics of the final product. Natural earth fillers can be included for a stronger product. Suitable fillers include, but are not limited to, clays such as bentonite, amorphous raw products such as gypsum (calcium sulfate dehydrate) and calcium sulfate, minerals such as limestone and man made materials such as fly ash. These natural earth fillers are able to take part in the cross linking and binding that occurs during the molding process. Other examples of useful fillers include perlite, vermiculite, sand, gravel, rock, limestone, sandstone, glass beads, aerogel, xerogels, seagel, mica, clay, synthetic clay, alumina, silica, fused silica, tabular alumina, kaolin, microspheres, hollow glass spheres, porous ceramic spheres, calcium carbonate, calcium aluminate, lightweight polymers, xonotlite (a crystalline calcium silicate gel), lightweight expanded clays, hydrated or unhydrated hydraulic cement particles, pumice, exfoliated rock, and other geologic materials. Partially hydrated and hydrated cement, as well as silica fume, have a high surface area and give excellent benefits such as high initial cohesiveness of the freshly formed article. Even discarded inorganically filled materials, such as discarded containers or other articles can be employed as aggregate fillers and strengtheners. It will also be appreciated that the containers and other articles can be easily and effectively recycled by simply adding them to fresh moldable mixtures as aggregate filler. Hydraulic cement can also be added in either its hydrated or unhydrated form. Both clay and gypsum can be important aggregate materials because they are readily available, relatively inexpensive, workable, form easily, and can also provide a degree of binding and strength if added in high enough amounts (for example in the case of gypsum hemihydrate). Because gypsum hemihydrate can react with the water within the moldable mixture, it can be employed as a means for holding water internally within the molded article. Preferably, the inorganic materials are added in an amount from up to approximately 5%, 0-4%, 0-13%, 2-13% or 0-15% by weight of the weight of the final composition.

Because of the wide variety of agents that can be used as fillers, preferred concentration ranges are difficult to calculate. For bentonite clay a preferred range is from about 2.5-4% of the weight of the final mixture. The additional agents can be predisolved or can be added dry. A preferred clay slurry is about 20% bentonite clay in water.

In addition, further cellulose-based thickening agents can be added, which can include a wide variety of cellulosic ethers, such as methylhydroxyethylcellulose, hydroxymethylethylcellulose, carboxymethylcellulose, methylcellulose, ethylcellulose, hydroxyethylcellulose, hydroxyethylpropylcellulose, hydroxypropylmethylcellulose, and the like. Other natural polysaccharide-based thickening agents include, for example, alginic acid, phycocolloids, agar, gum arabic, guar gum, locust bean gum, gum karaya, xanthan gum, and gum tragacanth. Suitable protein-based thickening agents include, for example, Zein® (a prolamine derived from corn), collagen (derivatives extracted from animal connective tissue such as gelatin and glue), and casein (derived from cow's milk). Suitable synthetic organic thickening agents include, for example, polyvinyl pyrrolidone, polyethylene glycol, polyvinyl alcohol, polyvinylmethyl ether, polyacrylic acids, polyacrylic acid salts, polyvinyl acrylic acids, polyvinyl acrylic acid salts, polyacrylamides, ethylene oxide polymers, polylactic acid, and latex. Latex is a broad category that includes a variety of polymerizable substances formed in a water emulsion. An example is styrene-butadiene copolymer. Additional copolymers include: vinyl acetate, acrylate copolymers, butadiene copolymers with styrene and acetonitrile, methylacrylates, vinyl chloride, acrylamide, fluorinated ethylenes. Hydrophilic monomers can be selected from the following group: N-(2-hydroxypropyl)methacrylamide, N-isopropyl acrylamide, N,N-diethylacryl-amide, N-ethylmethacrylamide, 2-hydroxyethyl methacrylate, acrylic acid 2-(2-hydroxyethoxy)ethyl methacrylate, methacrylic acid, and others, and can be used for the preparation of hydrolytically degradable polymeric gels. Suitable hydrophobic monomers can be selected from the 2-acetoxyethyl methacrylate group of monomers comprising dimethylaminoethyl methacrylate, n-butyl methacrylate, tert-butylacrylamide, n-butyl acrylate, methyl methacrylate, and hexyl acrylate. The polymerization can be carried out in various solvents, e.g. in dimethylsulfoxide, dimethylformamide, water, alcohols as methanol and ethanol, using common initiators of the radical polymerization. The hydrophilic gels are stable in an acidic environment at a pH of about 1-5. Under neutral or weak alkaline conditions at pH above about 6.5, the gels may degrade. The gels mentioned above are nontoxic as well as the products of their biodegradation.

Other polymers can include the following moieties: aliphatic polyester, poly caprolactone, poly-3-hydroxybutyric acid, poly-3-hydroxyvaleric acid, polyglycolic acid, copolymers of glycolic acid and lactic acid, and polylactide, PVS, SAN, ABS, phenoxy, polycarbonate, nitrocellulose, polyvinylidene chloride, a styrene/allyl alcohol copolymer, polyethylene, polypropylene, natural rubber, a sytrene/butadiene elastomer and block copolymer, polyvinylacetate, polybutadiene, ethylene/propylene rubber, starch, and thermoplastic segmented polyurethane, homopolymers or copolymers of polyesters, polyorthoesters, polylactides, polyglycolides, polycaprolactones, polyhydroxybutyrates, polyhydroxyvalerates, pseudopolyamino acids, polyamides and polyanhydrides, homopolymers and copolymers of polylactic acid, polyglycolic acid, polycaprolactone (PCL), polyanhydrides, polyorthoesters, polyaminoacids, pseudopolyaminoacids, polyhydroxybutyrates, polyhydroxyvalerates, polyphophazenes, and polyalkylcyanoacrylates.

Additional polymers that can be added include: citrates, diethyl citrate (DEC), triethyl citrate (TEC), acetyl triethyl citrate (ATEC), tributyl citrate (TBC), acetyl tributyl citrate (ATBC), phthalates such as dimethyl phthalate (DMP), diethyl phthalate (DEP), triethyl phthalate (TEP), dibutyl phthalate (DBP), dioctyl phthalate, glycol ethers such as ethylene glycol diethyl ether, propylene glycol monomethyl ether, ethylene glycol monoethyl ether, diethylene glycol monoethyl ether (Transcutol™), propylene glycol monotertiary butyl ether, dipropylene glycol monomethyl ether, n-methylpyrrolidone, 2 pyrrolidone (2-Pyrrol™), propylene glycol, glycerol, glyceryl dioleate, ethyl oleate, benzylbenzoate, glycofurol sorbitol sucrose acetate isobutyrate, butyryltri-n-hexyl-citrate, acetyltri-n-hexyl citrate, sebacates such as dibutyl sebacate, tributyl sebacate, dipropylene glycol methyl ether acetate (DPM acetate), propylene carbonate, propylene glycol laurate, propylene glycol caprylate/caprate, caprylic/capric triglyceride, gamma butyrolactone, polyethylene glycols (PEG), glycerol and PEG esters of acids and fatty acids (Gelucires™, Labrafils™ and Labrasol™) such as PEG-6 glycerol mono oleate, PEG-6 glycerol linoleate, PEG-8 glycerol linoleate, PEG-4 glyceryl caprylate/caprate, PEG-8 glyceryl caprylate/caprate, polyglyceryl-3-oleate, polyglyceryl-6-dioleate, polyglyceryl-3-isostearate, PEG-32 glyceryl laurate (Gelucire 44/1™), PEG-32 glyceryl palmitostearate (Gelucire 50/13™), PEG-32 glyceryl stearate (Gelucire 53/10™), glyceryl behenate, cetyl palmitate, glyceryl di and tri stearate, glyceryl palmitostearate, and glyceryl triacetate (Triacetin™), vegetable oils obtained from seeds, flowers, fruits, leaves, stem or any part of a plant or tree including cotton seed oil, soy bean oil almond oil, sunflower oil, peanut oil, sesame oil. The use of two or more plasticizers in a combination or blend of varying ratios and hydrophilicity or hydrophobicity is also possible. Plasticizers also include: phthalates, glycol ethers, n-methylpyrrolidone, 2 pyrrolidone, propylene gycol, glycerol, glyceryl dioleate, ethyl oleate, benzylbenzoate, glycofurol sorbitol, sucrose acetate isobutyrate, butyryltri-n-hexyl-citrate, acetyltri-n-hexyl citrate, sebacates, dipropylene glycol methyl ether acetate (DPM acetate), propylene carbonate, propylene glycol laurate, propylene glycol caprylate/caprate, caprylic/capric triglyceride, gamma butyrolactone, polyethylene glycols (PECs), vegetable oils obtained from seeds, flowers, fruits, leaves, stem or any part of a plant or tree including cotton seed oil, soy bean oil, almond oil, sunflower oil peanut oil, sesame oil, glycerol and PEG esters of acids and fatty acids, polyglyceryl-3-oleate, polyglyceryl-6-dioleate, polyglyceryl-3-isostearate, PEG-32 glyceryl laurate, PEG-32 glyceryl palmitostearate, PEG-32 glyceryl stearate, glyceryl behenate, cetyl palmitate, glyceryl di and tri stearate, glyceryl palmitostearate, and glyceryl triacetate. These materials can also be added in combination with other polymers to improve flexibility.

The addition of these items can increase the efficiency of production of the product on an item basis. Baking powder and materials such as leavening agents, (which release gases, e.g., sodium or calcium bicarbonates or carbonates) can also be included in the compositions to elevate the number of open cells in the final structure by introducing a source of carbon dioxide gas which is released in the mold.

Glycerol, microcrystalline wax, fatty alcohols and other similar organic molecules can be added as a mold release agent, and to produce a smoother surface on the finished product. Examples of agents that can be added, either as plasticizers or as mold releasing agents are ethylene glycol, propylene glycol, glycerin, 1,3-propanediol, 1,2-butandiol, 1,3-butandiol, 1,4-butanediol, 1,5-pentandiol, 1,5-bexandiol, 1,6-hexandiol, 1,2,6-hexantriol, 1,3,5-hexantriol, neopentylglycol, sorbitol acetate, sorbitol diacetate, sorbitol monoethoxylate, sorbitol diethoxylate, sorbitol hexaethoxylate, sorbitol dipropoxylate, arrunosorbitol, trihydroxymethylaminomethane, glucose/PEG, the reaction product of ethylene oxidewith glucose, trimethylolpropane monoethoxylate, mannitol monoacetate, mannitol monoethoxylate, butyl glucoside, glucose monoethoxylate, a-methyl glucoside, the sodium salt of carboxymethylsorbitol, polyglycerol monoethoxylate, erythritol, pentaerythritol, arabitol, adonitol, xylitol, mannitol, iditol, galactitol, allitol, sorbitol, polyhydric alcohols generally, esters of glycerin, formamide, N-methylformamide, DMSO, mono- and diglycerides, alkylarruides, polyols, trimethylolpropane, polyvinylalcohol with from 3 to 20 repeating units, polyglycerols with from 2 to 10 repeating units, and derivatives of the foregoing. Examples of derivatives include ethers, thioethers, inorganic and organic esters, acetals, oxidation products, amides, and amines. These agents can be added from 0-10%, preferably 3-4% (w/w). A consideration of the inventive mixture should be that the composition preferably contains at least 75%, more preferably at least 95% of natural or organic-derived materials by weight of the homogenous moldable composition.

Lubricants can be added to assist with flowability of the material in the mold. Exemplary lubricants include stearates, oleates, silicon oils, and the like. Preferably the lubricant is magnesium, calcium or sodium stearate. Preferably, food based lubricant materials are used.

Foaming agents may also be added. Exemplary foaming agents can include inorganic materials, for example, but not limited to, bicarbonates, carbonates, hydroxyl amines, and the like. The foaming agents function to produce smaller vacuoles in the matrix, resulting in material which is stronger and better insulated. One foaming agent is CT1480 (Clariant Masterbatches, Winchester Va.).

Preparation of Molded Articles

The starch-wood flour mixture, with any included additives, is added to the pre-gelled starch and mixed (for example with a Kitchen Aid® Commercial Mixer) until a homogeneous mixture is generated. The mixture can be as thick as peanut butter or as thin as a pancake batter. Varying amounts of additional water can by added to facilitate different types of molding, since the form of the pre-molded [green] product is dependent on the mold, heating rate and drying/melt time. If the product is to be molded by classic injection methods the material is generally thinner, if the material is molded on the equipment described below the mixture is generally thicker. The material can also be rolled into green sheets and molded, extruded and made into dry pellets for other processes. The means of production for the product could be created from any of several possible process approaches. One specific methodology is described below, however this description is intended only to describe one possible means of production, and shall not be construed in any way to represent a limitation to the outlined approach. While the compression molding process detailed herein is useful, other types of compression molding, injection molding, extrusion, casting, pneumatic shaping, vacuum molding, etc can be used.

One embodiment involves a means of production incorporating moving upper and lower continuous track assemblies each with an upper and lower substantially elongated horizontal section, and with a curved portion of track joining the upper and lower horizontal section for each of the upper and lower tracks. Riding in each of the track assemblies is a linked belt made from any material or combination of materials that allows the belt or belt assembly to be in constant or intermittent motion about the tracks. The track assemblies are located vertically such that the upper portion of the lower track and the lower portion of the upper track are in close proximity such that the belts of each track move at a synchronized speed and in a common direction. In this embodiment, a male mold portion is mounted to the belt following the upper track, and a female portion of the mold is mounted to the belt following the lower track, with the tracks synchronized in a fashion that causes the mold halves to join and close as they merge between the upper and lower tracks. In this embodiment, the material to be processed is deposited into the female mold half prior to the mold haves closing, or is injected into the mold after it has been closed. The track and belt assemblies hold the mold halves together during drying by any of a number of, or combination of, methods including without limitation spring force, pneumatic force, or mechanical compression. Other forcing methods are possible. One possible arrangement of the curved end of the tracks aligns them such that the lower tracks' upper horizontal section are located to start before the upper tracks' lower horizontal section to allow the female mold half on the upper section of the lower track to assume a substantially horizontal orientation prior to the male mold half attached to upper track, thereby allowing the female mold half to receive deposited material before it engages the corresponding male mold half merging from the upper track and belt assembly. Other aspects that can be incorporated in this embodiment include, removable cavity inserts and or multiple cavities in the molds: heating of the molds or product to speed drying by electric, microwave, hot gas, friction, ultrasonic, or any other means: on the fly cleaning of the molds, on the fly coating of product with any of a number of coating agents.

In another embodiment, once the moldable mixture has been prepared, it is positioned within a heated mold cavity. The heated mold cavity can comprise many different embodiments, including molds typically used in conventional injection molding processes and die-press molds brought together after placing the inorganically filled mixture into the female mold. In one preferred embodiment, for example, the moldable mixture is placed inside a heated female mold. Thereafter, a heated male mold is mated with the complementarily heated female mold, thereby positioning the mixture between the molds. As the mixture is heated, the starch-based binder gelates, increasing the viscosity of the mixture. Simultaneously, the mixture increases in volume within the heated molds cavity as a result of the formation of gas bubbles from the evaporating solvent, which are initially trapped within the viscous matrix. By selectively controlling the thermodynamic parameters applied to the mixture (e.g., pressure, temperature, and time), as well as the viscosity and solvent content, the mixture can be formed into a form-stable article having a selectively designed cellular structural matrix.

In a non-limiting embodiment, a temperature between about 195-225° C., preferably about 200° C. is used for baking for a time period of about 60-90 seconds, preferably about 75 seconds. Temperatures can vary based on the article bring manufactured, for example, 200° C. is preferred for the rapid production of thin-walled articles, such as cups. Thicker articles require a longer time to remove the solvent and are preferably heated at lower temperatures to reduce the propensity of burning the starch-based binder and fiber. Leaving the articles within the locked molds too long can also result in cracking or deformation of the articles.

The temperature of the mold can also effect the surface texture of the molds. Once the outside skin is formed, the solvent remaining within the interior section of the mixture escapes by passing through minute openings in the outside skin and then traveling between the skin and the mold surface to the vent holes. If one mold is hotter than the other, the laws of thermodynamics would predict, and it has been empirically found, that the steam will tend to travel to the cooler mold. As a result, the surface of the article against the hotter mold will have a smoother and more uniform surface than the surface against the cooler mold.

A variety of articles can be produced from the processes and compositions of the present invention. The terms “article” and “article of manufacture” as used herein are intended to include all goods that can be formed using the disclosed process.

Other Biodegradable Containers

PCT Publication No. WO 99/02598, filed by Business Promotions, Inc., describes a method for making a biodegradable product for use as a container for foodstuffs, including hot and cold liquids. The product is manufactured under pressure and heat in a mold, based on a basic material made of amylose-containing flour (derived from an edible crop plant), wood flour, natural wax and water. The basic material consists substantially of a moist granulate comprising flour (50-250 parts by weight), wood flour (10-85 parts by weight), natural wax (2-30 parts by weight) and water (50-250 parts by weight).

European Patent 0773721B1 to Cooperatieve Verkoop describes compounds made of a starch suspension and a wax coating, which are baked into a base mold. The coating is made of a wax composition comprising at least 50% wax and having a melting temperature of at least 40° C. The starch composition is preferably made by a process that includes 5-75% of a starch derivative which has a reduced swelling capacity at increased temperatures when compared to native starch.

PCT Publication No. WO 01/60898, (filed by Novamont), describes products such as sheets of different thicknesses and profile based on destructured or complexed starch, which are biodegradable. In particular, the patent claims partly-finished products, for example a foam sheet material, comprising destructured or complexed starch foamed as a continuous phase, having a density between 20 and 150 kg/m³, cell dimensions in a range between 25 and 700 μm with a cell distribution such that 80% of them have a dimension between 20 and 400 μm.

U.S. Pat. No. 6,451,170 to Cargill, Inc. describes improved starch compositions of cross-linked cationic starch, used in the papermaking process. The '170 patent claims the following papermaking process: 1) providing a cationized cross-linked starch component having a hot paste viscosity in the range of from about 200 to 3000 cps (as measured in a Brookfield viscometer at about 95° C. using a No. 21 spindle); 2) cooking a first portion of the starch component to generate a cooked starch component at an average cooking temperature below 330° F. for a period of time; 3) dewatering a paper furnish (wherein the paper furnish includes: (i) cellulosic fibers in an aqueous slurry, (ii) inorganic particles comprising at least 50 percent by weight particles having an average particle size of no greater than 1 micron, and (iii) the cooked starch component); and 4) adjusting the dewatering rate by cooking a second portion of the starch component at an average temperature at least 10° F. different than the first cooking temperature. The fourth step in the papermaking process can also include adjusting the first pass retention during dewatering by cooking a second portion of the starch composition at an average temperature at least 10° F. different than the first cooking temperature.

U.S. Pat. No. 5,122,231 to Cargill, Inc. describes a new cationic cross-linked starch for use in papermaking in the wet end system of a paper machine using a neutral or alkaline finish. The '231 patent describes methods to increase starch loading capacity in a papermaking process in which the papermaking process has a pH of about 6 or greater. One method is directed to adding the cationized cross-linked starch to a paper furnish of the process prior to the conversion of the furnish to a dry web wherein the starch is cationized to a degree of substitution on the hydroxyl groups of the starch between about 0.005 and 0.050 and wherein after the cationization the starch is cross-linked to a hot paste viscosity in the range of from about 500 to 3000 cps (as measured on a Brookfield viscometer at about 95° C. using a No. 21 spindle). Another method is directed to adding cationized cross-linked starch to a paper furnish of the process in an amount effective for making Zeta potential of the furnish about zero and wherein the starch is cationized with monovalent cations and has a degree of substitution of monovalent cations on the hydroxyl groups of the starch between about 0.005 and 0.050 and wherein after cationization the starch is cross-linked to a hot paste viscosity in the range of from about 500 to 3000 cps (as measured on a Brookfield viscometer at about 95° C. using a No. 21 spindle).

U.S. Pat. Nos. 5,569,692 and 5,462,982, (both assigned to Novamont), describe a composition for a biodegradable material which can be used at high temperatures comprising destructured starch, a thermoplastic polymer, and a plasticizer having a boiling point higher than 150° C. in an amount from 20 to 100% based on the weight of starch, said destructured-starch being obtained by destructuring starch as it is, without the addition of water. The inventors found that if a starch is destructured as it is, with the addition of a high-boiling plasticizer (such as glycerine) and a destructuring agent (such as urea), in an extruder heated to a temperature below the boiling point of the plasticizer (but between 120 and 170° C.), destructured starch compositions are obtained which can be mixed with polymers having relatively high melting points and are suitable for extrusion at temperatures higher than 120° C. at low pressure. The compositions thus obtained are particularly suitable for subsequent operations such as thermoforming and blowing.

U.S. Pat. No. 5,252,271 to Bio-Products International describes a material that is based on a dry starch composition, having no greater than 30% water content; which is mixed with a mild acid in dry, powdered form (preferably malic acid, tartaric acid, citric acid, maleic acid and succinic acid) at a percentage of 0.2 to 7% of the total starch composition. Adding a dry, powdered carbonate composition capable of reacting with acid to generate CO₂ gas at a composition percentage of 0.1 to 2% of the total starch composition and mixing and advancing the product with water within an extrusion barrel of the extrusion means to generate elevated heat and pressure for converting the material to a gelatinous state that can be dried and remain pliable.

U.S. Pat. No. 4,863,655 to National Starch and Chemical Corp. describes a biodegradable packaging material comprising an expanded, high amylose starch product having at least 45% (by weight of the final material) amylose content and a low density, closed cell structure with good resilience and compressibility. Another embodiment provides a method of preparing the packaging material with a total moisture content of 21% or less by weight, at a temperature of from 150 to 250° C.

U.S. Pat. No. 5,428,150 to Cerestar Holdings describes a method for making a starch-containing composition to produce a material suitable for the production of molded articles in which the composition contains in addition to the starch a starch degradation product selected from starch hydrolysis products having dextrose equivalent's of 1 to 40, particularly a maltodextrin, oxidized starches and pyrodext.

U.S. Pat. Nos. 5,660,900, 5,868,824, and PCT Publication No. WO 96/05254 (filed by Khashoggi) describe compositions for manufacturing biodegradable articles from highly inorganically filled materials having a starch-based binder. These documents describe articles of manufacture that have high levels of the inorganic filler in a polymer matrix without adverse affects on the properties of the binding system. The articles contain a matrix of starch and at least one inorganic aggregate, present as at least about 20% by weight (or 5% by volume) of the final mixture. The matrix is prepared from about 10 to 80% of a starch-based binder that has been substantially gelatinized by water and then hardened through the removal of a substantial quantity of the water by evaporation with an inorganic aggregate dispersed throughout the starch-bound cellular matrix. The mixture is designed with the primary considerations of maximizing the inorganic components, minimizing the starch component and solvent, and selectively modifying the viscosity to produce articles that have the desired properties for their intended use.

U.S. Pat. Nos. 5,736,209 and 5,810,961, and PCT Publication No. WO 97/37842, (assigned to Kashoggi Industries), describe methods to develop biodegradable paper and products which include a binding matrix of starch and cellulosic ether, and fibers substantially homogeneously dispersed throughout the matrix. The '209 patent discloses a concentration range for the starch of about 5% to 90% by weight of solids in the sheet, for the cellulosic ether a range from about 0.5% to 10% by weight of solids, and for fibers a concentration range from about 3% to 40%. Optionally, an inorganic mineral filler can be added. Sheets produced using this biodegradable material having a thickness less than about 1 cm and a density greater than about 0.5 g/cm³ are described.

PCT Publication No. WO 01/51557, (filed by Khashoggi), is describe to compositions and methods for manufacturing thermoplastic starch compositions having a particulate filler (present in an amount greater than about 15% by weight of the thermoplastic starch) with optional fiber reinforcement. Native starch granules are made thermoplastic by mixing and heating in the presence of an appropriate plasticizer (including somewhat polar solvents such as water or glycerin) to form a starch melt. The starch melt is then blended with one or more non-starch materials to improve properties and reduce cost of the resulting thermoplastic starch composition. A particulate filler component is thereafter blended with the starch melt, preferably an inexpensive, naturally occurring mineral particulate filler (“inorganic filler”), included in an amount greater than about 15% by weight of the thermoplastic starch composition. In addition, this reference describes a composition comprising a thermoplastic starch melt having a water content of less than about 5% by weight while in a melted state, wherein at least one plasticizer has a vapor pressure of less than about 1 bar when in a melted state and in which a solid particulate filler phase is dispersed and included in an amount from about 5% to 95% by weight. An additional embodiment describes dispersion of a solid particulate filler phase in an amount from about 5% to 95% by weight of the thermoplastic starch composition and a fibrous phase in a concentration of from about 3% to 70% by weight.

U.S. Pat. No. 6,168,857 (Khashoggi Industries) describes a starch-bound sheet having a thickness less than about 1 cm and a density greater than about 0.5 g/cm³ comprising: (a) a binding matrix including starch and an auxiliary water-dispersible organic polymer, wherein the starch has a concentration greater than about 5% by weight of total solids in the sheet; and (b) fibers substantially homogeneously dispersed throughout the starch-bound sheet; and optionally an inorganic mineral filler.

U.S. Pat. Nos. 5,618,341, 5,683,772, 5,709,827, and 5,679,145 and PCT publication No. WO 97/2333, (assigned to Khashoggi Industries), describe starch-based compositions that can be used in making containers. U.S. '341 and '145 teach methods for dispersing fibers within a fibrous composition comprising the steps of: (a) combining water, fibers, and a thickening agent (such as a pregelatinized starch) such that the thickening agent and water interact to form a fluid fraction that is characterized by a yield stress and viscosity that enables the fibers to be substantially uniformly dispersed throughout the fibrous composition as the fibers and fluid fraction are mixed, the fibers having an average length greater than about 2 mm and an average aspect ratio greater than about 25:1; and (b) mixing together the combined thickening agent, water, and fibers in order to substantially uniformly disperse the fibers throughout the fibrous composition. The thickening agent is included in an amount ranging from about 5% to 40% by weight of the fluid fraction. The described method involves a fluid system that is able to impart shear from a mechanical mixing apparatus down to the fiber level in order to obtain a starch-based composition having substantially uniformly dispersed fibers. The '772 patent describes an inorganic filler to enhance the strength and flexibility of the articles. The '827 patent describes methods to make the article of manufacture that is developed from mixtures including fibers having an average aspect ratio greater than about 25:1. The '341, '772, '827, and '145 patents and WO 97/2333 application describe high aspect ratios (i.e., about 25:1 or greater) and long-length (i.e., at least about 2 mm) fibers to reinforce the structure. PCT publication No. WO 97/23333 describes articles that contain high starch contents (from about 50 to 88% by weight ungelatinized and about 12% to 50% by weight of gelatinized starch).

U.S. Pat. No. 6,303,000 (Omnova Solutions) describes a method to improve the strength of paper by adding an aqueous cationic starch dispersion modified with a blocked glyoxal resin to a paper pulp slurry. The starch dispersion is prepared by gelatinizing an aqueous suspension of starch granules (including potato, corn, waxy corn, red and white milo, wheat and tapioca, thin-boiling starches, and starches that have been additionally chemically modified) and reacting the starch with a blocked glyoxal resin at temperatures of at least 70° C., preferably 85 to 95° C. Suitable blocked glyoxal resins which can be used include cyclic urea/glyoxal/polyol condensates, polyol/glyoxal condensates, urea or cyclic urea/glyoxal condensates and glycol/glyoxal condensates in an amount from about 3% to 30%, preferably 9 to 20%, of the total dry weight of starch. The resulting gelatinized starch composition can be cooled and stored, or can be added directly to a dilute paper pulp slurry to increase the tensile strength and elasticity of the resulting paper product.

PCT Publication No. WO 01/05892 (filed by Kim & Kim), describes methods for manufacturing plastic-substitute goods by using natural materials by preparing a glue made by mixing 20% by weight of a starch and 80% by weight of water together, heating this mixture; washing and drying rice husks to a drying extent of 98%; mixing the glue and the rice husks together so as to form a mixture of the glue and the rice husks, drying them to a drying extent of 98%, and crushing them to a size range of 0.01-0.1 mm. Then, mixing 80% by final weight of the mixture of the glue and the rice husks, 5% by final weight water, and 15% by final weight of rosin to form a final mixture; and molding the final mixture using a molding machine at a temperature of 100-350° C. under a pressure of 5 kg/cm at a production frequency of 30-80 seconds per product.

PCT Publication No. WO 02/083386 (filed by Kim & Kim), describes methods for manufacturing plastic-substitute goods by using natural materials using a starch-based glue and melamine resin. Melamine or urea resin is a thermosetting resin which is formed by reaction of melamine or urea acting upon formaldehyde. The products are manufactured by first preparing a mixture of 20% by weight starch and 80% by weight water, heating this mixture; washing and drying rice husks to a drying extent of 98%; mixing the glue and the rice husks together so as to form a mixture of the glue and the rice husks, drying them to a drying extent of 98%, and crushing them to a size range of 0.01-0.1 mm. Melamine resin is obtained by a process of first, mixing 30% by weight of formaldehyde solution and 70% by weight of water, 30% by weight of melamine or urea and heating the mixture at a temperature of 350° C. A mixture is then made of 70% by final weight of the mixture of the glue and the rice husks, 15% by weight of water, and 15% by weight of melamine resin to form a final mixture. The final mixture is molded by a molding machine at a temperature of 100 350° C. under a pressure of 5 kg/cm at a product ion frequency of 30-80 seconds per product.

U.S. Publication No. US 2002/0108532 and PCT Publication No. WO 00/39213 (filed by Apack AG) describe methods to produce a shaped body made of biodegradable material that shows good expansion behavior during thermoforming from 7.6 to 8.5% by weight of cellulosic fibers, from 16.1 to 17.6% by weight of native starch, from 5.4 to 6% by weight of pregelatinized starch and from 68.0 to 70.6% by weight of water. First, the pregelatinized starch is produced by mixing between 5.4-6% starch and 94-94.6% water, heating the mixture to 68-70° C., holding the mixture constant at 68-70° C. for 10 minutes, and cooling the pregelatinized starch to 50° C. Then, adding the 16.1 to 17.6% by weight of native starch, 7.6 to 8.5% by weight of cellulosic fibers, and 68.0 to 70.6% by weight of water to the pregelatinized solution at a temperature of 50° C.; mixing for 5 minutes to achieve a homogeneous mixture at 40° C., not allowing the mixture to substantially cool, and placing the mixture in a baking mold, and baking the mixture at 100-200° C. for 10-100 seconds to form the shaped body.

German patent DE 19,706,642 (Apack Verpackungen Gmbh) describes the production of a biodegradable article from 25-75% fibers, 13-38% starch and 13-38% water. First, the 25-75% fibers, 13-38% starch are mixed in a dry state in a continuous process; then water is admixed continuously. The mixture is then subjected to a baking process to obtain the finished molded article, and then the molded article is coated with a biologically degradable film that is impermeable to humidity.

Filming of Molded Articles

The present invention provides an improved methods and materials for filming biodegradable or compostable containers, such as starch-based biodegradable or compostable containers, by applying a heated biodegradable film to a heated container, wherein the temperature of the container is approximately the melt temperature of the film. The heating of the container prior to the application of the film provides improved results by improving the attachment of the film to the container. Also provided are containers made by the processes disclosed herein.

In particular, the present invention provides a method for filming a biodegradable or compostable container which is suitable for holding hot foods or beverages.

Any suitable method can be used to film the biodegradable or compostable containers. In one embodiment, the film is a liquid and can be applied, for example, by spray coating, dip coating or painting the film onto the surface of the container. In another embodiment, the film is a solid and can be applied, for example, by a vacuum.

A heated biodegradable or compostable container is provided, wherein the temperature of the heated container is approximately the melt temperature of the film. The melt temperature of the film may vary, and for example, may range from about 50 to about 200° C. For example, the melt temperature is about 50, 60, 70, 80, 90, 100, 110, 115, 120, 125, 130, 135, 140, 145, 150, 155, 160, 165, 170, 175, 180, 185, 190, 195 or 200° C. or more. In one embodiment, the melt temperature is from about 70 to about 200° C., from about 80 to about 180° C., from about 90 to about 170° C., from about 100 to about 160° C., from about 110 to about 150° C., or from about 120 to about 140° C.

In one embodiment, the melt temperature of the film is higher than the boiling point of substance to be held in the container. For example, the melt temperature of the film is higher than the boiling point of water, i.e., 120° C. For example, the melt temperature of the film may be about 120 to about 190 or from about 145-170° C. The suitable temperature may be selected based on the container and film used.

The container provided is at a temperature that is approximately the same as the melt temperature of the film. In one embodiment, the heated container is within about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 40 or 50° C. of the melt temperature of the film. In a particular embodiment, the heated container is within about 110° C. of the melt temperature of the film.

Examples of suitable films include biodegradable or compostable films with a melt temperature of about 120 to about 190° C. or more. The films may be, for example, a polyester, polyolefin, polyacetic acid, polyethylene or copolymers thereof. In particular, the film may be a biodegradable, aliphatic aromatic copolyester, such as BASF Ecoflex®®, having a melt temperature of about 145 to about 170° C.

In particular, a method of filming a biodegradable or compostable container is provided, comprising applying a heated film to a heated container. The heating of the container prior to the application of the film provides improved results, and improves the attachment of the film to the container. Also provided are containers made by the processes disclosed herein.

Films can be applied by physically placing a sheet over the molded container and applying heat to adhere the sheet to the container. Alternatively, a liquid containing the biodegradable filming material can be applied to the container by a variety of methods, including but not limited to, spray coating, dip coating, painting and the like.

In some embodiments, the container may be heated, e.g., to at least 70, 80, 90, 100, 110, 120, 130, 140, 150, 160, 170, 180, 190, 200 or more degrees Celsius. For example, the container may be heated to about 70-100, 80-120, 110-140, 140-160, 145-170, 150-180° C. or other suitable temperature to improve adhesion of the film to the container.

In one embodiment, a biodegradable or compostable container is heated to approximately the melt temperature of the film prior to application of the film. In some embodiments, the container may be heated, e.g., to at least 70, 80, 90, 100, 110, 120, 130, 140, 150, 160, 170, 180, 190, 200 or more degrees Celsius, depending on the film used. For example, the container may be heated to about 70-100, 80-120, 110-140, 140-160, 145-170, 150-180° C. depending on the melt temperature of the film. For example, the melt temperature of the film may be about 145-170° C. The suitable temperature may be selected based on the container and film used.

In particular embodiments, a film is selected which has a sufficiently high melt temperature that it will not melt upon contact with hot food or not beverages. For example, the film may be a biodegradable or compostable film having a melt temperature of at least 50, 60, 70, 80, 90, 100, 110, 120, 130, 140, 150, or 160° C. or more. Thus, the method can include heating up the film to about its melt temperature prior to applying the film to the heated container.

Examples of suitable films include biodegradable or compostable films with a melt temperature of about 120-190° C. or more. For example, BASF Ecoflex® (biodegradable, aliphatic aromatic copolyesters) can be used, with a melt temperature, e.g., of about 145-170° C. This polymer is highly suitable because the melt temperature is well above the boiling point of water, so that it is suitable for use with hot foods and liquids. Some polymer films, such as for example Ecoflex®, will melt over a range of temperatures. Ecoflex® may also include minor amounts of PLA.

In certain embodiments, a blow molded film from feedstock resin produced by BASF (Germany), such as Ecoflex 1340, which is biodegradable may be compostable in a commercial facility, is used. A commercial composting facility is different from an individual compost pile in that the materials are 2-10 times wetter, maintained at a temperature of about 30-60° C., and constantly turned to speed up the degradation process. Films made from this polyester-based resin have a high heat tolerance with melt temperatures ranging from 145-170° C. This temperature tolerance is much higher than that of most other biodegradable and compostable films, such as for example, polylactic acid (PLA) based films which have melt temperatures so far below the boiling point of water as to render them unsuitable when used alone for coffee or hot food containers. A coating of these PLA films on the walls of containers will melt and allow the hot liquid to permeate and soften the container wall. Film coatings which consist mainly of PLA may also include inorganic additives to increase the melting point, decrease vapor transport rate, or increase tear strength of the film. One supplier of the PLA based films is DaniMer Scientific (Banbridge, Ga.).

Petrochemical based films, such as those produced by BASF, can include, but are not limited to, polyolefins, aliphatic aromatic polyesters, and PLA.

In particular embodiment, the film is or comprises a biodegradable polyester or co-polyester with a melt temperature in the range of about 110-190° C. or higher.

Other suitable films can include films produced from petrochemical products, such as for example, polyethylene, Cortec® (Minnesota) Eco Film™, Innovia Films Inc. Transparent NatureFlex™ films derived from renewable wood pulp sources, and Eastar Bio biodegradable copolyester (Novamont SpA, Italy). Many of the biodegradable petrochemical based films include proprietary additives, such as for example, metal salts, which assist in the degradation and composting of the materials. Preferably, the petrochemical based films become biodegradable and compostable within 180 days of use.

Biodegradable films for use in the present invention may also be derived from non-petrochemical based stocks, such as for example, from renewable plant sources. Examples include the Starpol 2000 (Stanelco, Inc., Orlando, Fla.) family of films and films produced from β-hydroxy butyrate. The Starpol films are derived from sustainable crop production and are not derived from PLA.

Petrochemical based films can include various additives to make them “greener”, that is, they become biodegradable and in some cases compostable, at 180 days. Short chain low density polyethylene is one petrochemical based polymer that readily degrades. Other polymer types can be used such as low molecular weight polyesters, low molecular weight polypropylenes and other similar polymers. To increase bonding, films may be laminated with various adhesives (such as those produced by Cadillac Plastic Co, Troy, Mich.). The laminates can be applied either as a bonding of a second film onto the base film using rollers, or the laminate is added during the blow molding process using a second set of extruders within the same mold face. The laminate(s) are chosen to enhance the performance of the film, such as adding a thin layer of an polyester adhesive or a thin layer of PLA to enhance bonding and in some cases a second film to improve the gas transmission attributes of the base film.

The films can include one or more additional materials depending on the desired characteristics of the end product. Suitable fillers for the film include, but are not limited to, clays such as bentonite, amorphous raw products such as gypsum (calcium sulfate dehydrate) and calcium sulfate, minerals such as limestone and man made materials such as fly ash. These natural earth fillers are able to take part in the cross linking and binding that occurs during the molding process. Other examples of useful fillers include ultrafine sand, powdered limestone, micro glass beads, mica, clay, synthetic clay, alumina, silica, fused silica, tabular alumina, kaolin, microspheres, hollow glass spheres, porous ceramic spheres, calcium carbonate, calcium aluminate, lightweight polymers, lightweight expanded clays, hydrated or unhydrated hydraulic cement particles, pumice, and natural and synthetic nanoparticles.

The heated film in one embodiment is applied to the heated container using a vacuum forming filming technique. This allows the film to be drawn down efficiently onto the container surface. The vacuum-forming filming technique may be used where, for example, a container is placed in a nest that is a receptacle conforming to the contours of the external surfaces, and the vacuum holes within the nest interior are numerous and distributed in such a manner as to facilitate the movement of the film into the deepest part of the container.

Alternatively, or in combination with the vacuum technique, the heated film can be made to conform to the contours of the molded article by application of a stream of pressurized air which operates to push the film into the corners of the molded article. Optionally, the pressurized air stream may be heated. Alternatively, or in combination with the vacuum technique, the heated film may be applied to the molded article by using an object shaped like the molded article referred to as a plug. Optionally, the plug may be heated.

The application of a film to a biodegradable or compostable container preferably is not made after the container has cooled significantly. The cooler the container, the less likely is the film to adhere to the starch-based substrate. When the biodegradable or compostable container is filmed at a temperature near to or greater than the melt point of a specific film, that film has a greater adhesion to the starch based container. The methods described herein promote film adhesion to the container to the extent that it becomes fit for the retention of hot or cold liquids in commercial and domestic applications.

The film applied to the container can have any suitable thickness, for example, about 0.25-15 mil, 0.25-10 mil, 0.25-5 mil, 0.25-2 mil, 0.5-5 mil, 0.5-2 mil, 0.5-1 mil, 1-5 mil, 1-10 mil, 2-5 mil, 2-10 mil, 5-10 mil, or 5-15 mil, preferably about 0.25, 0.5, 0.75, 1, 1.5, 2, 3, 5, 10 or 15 mil. Shallow containers may have thinner films, while deeper containers may have thicker films.

In one embodiment, a sheet of blow molded film, such as Ecoflex 1340, with a melt point between 145 and 170° C. is cut to fit the holder of a traditional vacuum forming machine. The container is heated in an oven to a temperature within the melt range, to simulate a temperature that is consistent with that of the actual manufacturing process. The container is transferred to the nest within the vacuum machine and the film holder closed over the container. Using the flash heater of the forming unit the film is quickly heated to a temperature just above the melt point of the specific film. The time to flash heat the film is dependent on the given type of heating system and the construction of any specific filming unit. A vacuum is applied and the softened film is drawn into the container. The film and container are allowed to cool to a temperature below the melt point, the filmed container is removed and any excess film and/or rough edges of the container are trimmed, by classic methods, to its final size.

In one embodiment, a 1.75 mil biodegradable and compostable BASF film, such as Ecoflex 1340, is cut and placed into the holder. The container is heated to a temperature of 150 to 175° C. and placed in the nest. The film is surface heated to a temperature of 145 to 160° C. within 15 seconds and the vacuum applied to pull the film into the container and the system is cooled.

In another embodiment, a 1.75 mil biodegradable and compostable BASF film, such as Ecoflex 1340, is cut and placed into the holder. The container is heated to a temperature of 175° C. and placed in the nest. The film is surface heated to a temperature of 155° C. within 12 seconds and the vacuum applied to pull the film into the container and the system is cooled.

In another embodiment, a 1.75 mil film is heated to 165° C. within 10 seconds, container heated to 175° C. In one embodiment, a 5 mil film is heated to 165° C. within 16 seconds, and the container heated to 175° C. In another embodiment, a 10 mil film is heated 165° C. within 20 seconds, and the container heated to 175° C.

It may be desirable to apply print or other indicia, such as trademarks, product information, container specifications, or logos, on the surface of the article. This can be accomplished using any conventional printing means or processes known in the art of printing paper or cardboard products, including planographic, relief, intaglio, porous, and impactless printing. Conventional printers include offset, Van Dam, laser, direct transfer contact, and thermographic printers. However, essentially any manual or mechanical means can be used.

When using a vacuum to form a film around the molded article, increasing the levels of wood flour/fiber and/or paper pulp can facilitate the vacuuming process. For example, wood flour/fiber and/or paper pulp levels can be increased to approximately 30, 40 or 50% by weight of the final mixture.

In another embodiment, the container is coated with a biodegradable composition applied in liquid form. In this case, the film can be dissolved in a suitable solvent and applied to the container by known conventional means, including spray coating, dip coating, painting, and the like. Any film which can be dissolved in liquid can be applied in this manner, such as for example, the PLA based films. The liquid may be heated prior to application, or it may be applied at room temperature to the container. In some embodiments, the film is allowed to air dry. In other embodiments, the container is heated after the film has been applied. The object is preferably heated to a temperature about the same of the melting point of the film, i.e., up to 225° C., up to 200° C., or up to 175° C. The film can be between 0.1 and 5 mil, preferably between 0.25 mil and 1 mil.

The film polymer/resin can be dissolved into an appropriate solvent by either sonication, rapid stirring, by heating and slow cooling, or a combination thereof. The solvent selected is specific to the polymer/resin selected. For example, an appropriate solvent for ethyl cellulose, (or any other modified celluloses of differing polymer length), is ethyl alcohol or ethyl alcohol:water (having a ratio of alcohol:water of greater than 8:1). Generally, the longer the cellulose backbone the more alcohol is required. The liquid is then sprayed on, rolled on, brushed on, or applied by direct offset to the molded container and dried is a solvent recovery cabinet. The polymer can be applied in very thin coats of 0.2 mil or as high as 1.25 mil, depending on the concentration of solids and the rate of application. Other alcohols, such as for example, isopropanol, propanol and low molecular weight alcohol mixtures may also be used, depending on the molecular weight of the modified cellulose. Some PLA based films can be dissolved by a proprietary process in an FDA approved solvent such as 1,3-Dioxolane and applied as noted above. Other wax-like resins (such as mixtures of classic waxes and oleate/sterates, from DaniMer Scientific and others) and set point high melt waxes (S & S Chemical, Durango, Colo.) can be applied directly using heated systems and nozzles similar to the systems used to apply thermoset glues. The high melt waxes are generally only used as a very thin layer due to the tendency of wax-like materials to crack or craze.

Films used in the present invention are selected based upon the container to which the coating is being applied as well as the properties of the film, as applied. Properties of interest include, but are not limited to, water vapor transmission rates (hereinafter VTR), oxygen transfer rates, stretch factors, bonding modes between the film and starch based containers, melting points, orientation of the polymer within the film, and tear strength. Bonding modes can include cohesive attractions between the starch based container and starches in the film, adhesive attractions based on adhesives applied to the films, corona treatments to increase the dyne factor of a film, and low melting polymers that can be laminated to the film.

VTR is highly dependent on the end use of the container. For example, for “dry” trays or other dry use containers, VTR is not as important factor because the materials being placed in the container are substantially moisture free. In contrast, VTR is more important in “damp” trays or other damp use containers. For example, if a fruit is placed in the container for up to five days and the fruit expires significant amounts of water vapor, the VTR must low enough to restrict absorption by the container to maintain the structural integrity of the container. In addition, the film is preferably aggressively bonded to the container because the container-film interface is the first to receive any transferred vapor. Aggressive bonding can be accomplished, for example, by using an adhesive to bond the film to the molded article. Transferred vapor will “soften” the starch surface and can reduce the film bonding, eventually leading the peeling of the film from the container. Another application is the deli or restaurant tray or container that must hold food for a short, up to six hours, time. In this case the VTR can be higher since the VTR is slow enough to hold back enough vapor to keep the container-film interface intact. In some of these cases the tear strength is important since plastic knives may contact the film and cut through the film and allow moisture to invade the starch matrix. For “wet” trays or other wet use containers the VTR is preferably very low, due to the direct contact of the container with moisture. In some instances, these containers must remain intact for up to fourteen days or frozen for up to one year.

Preferably, the VTR of the film for a dry container is less than about 900 g H₂O/100 in² per 24 hours. In contrast, VTR of a film for a damp container can be from between about 25-400 g H₂O/100 in² per 24 hours, 50-200 g H₂O/100 in² per 24 hours, 50-100 g H₂O/100 in² per 24 hours, or 100-400 g H₂O/100 in² per 24 hours. The VTR of a film for a wet container is less than about 5 g H₂O/100 in² per 24 hours, less than about 4 g H₂O/100 in² per 24 hours, less than about 3 g H₂O/100 in² per 24 hours, or preferably less than about 2 g H₂O/100 in² per 24 hours.

The oxygen transfer rate [OTR] of the film may be important depending on the goods being retained. For example, many wet use trays are used for modified air packaging, i.e. in situations where specific gases may be introduced into the package to maximize the shelf life of product retained within the container (e.g., meats or prepared foods). In these cases the film must maintain the modified air for up to twenty-one days without pealing off or softening the tray beyond specific guidelines.

The importance of physical properties, such as for example, binding, stretch and orientation of the film, is based partially on the shape of the container. For example, for “dry” trays or other dry use containers, shallow trays do not require a great deal of stretch, but instead require good adhesion between the film and the tray surfaces. Films applied to deeper trays or bowls preferably have more stretch and may include an adhesive to achieve more aggressive bonding between the film and the molded container. In addition, films applied to deeper trays and bowls are preferably axially oriented.

The melting point of the film has been previously discussed and is based upon the end use of the product. For example, films applied to containers for use with hot water or hot coffee require a melting point higher than the boiling point of water, preferably at least 20 degrees Celsius greater than the boiling point of water.

Films based on PLA typically have a high VTR and thus are good for use with dry based containers. In addition, they have very low melting points that make use with hot liquids undesirable. Because of the low melting point, commercial transport of PLA based containers can be costly for pure PLA trays, and to a lesser extent, for trays having a PLA film applied thereto, where the low melting point can be overcome by the starch film interface and is stable at most commercial transport temperatures.

Additives can be added to PLA films to improve properties and decrease production costs. PLA films are traditionally more expensive to produce than petrochemical based films. Addition of inorganic and organic fillers, such as but not limited to, calcium carbonate, calcium sulfate, talc, clays, nano-clays, small amounts of petrochemical based resins that have been rendered biodegradable/compostable, glass beads, waxes having high melting points, fumed silica, processed diatoms, processed fly ash and micro-crystalline cellulose products make modified PLA films more economical, reduce the VTR and increase the effective melting point.

Petrochemical based films that include high levels of PLA can be used for both dry and damp applications. The relative amounts of the petrochemical based film and the PLA can be selected to achieve desired VTR, OTR and melting point. In addition, petrochemical based films which include PLA can also include the organic and inorganic filler additives described above. As with pure PLA films, additives can be added to reduce costs, decrease VTR. decrease OTR and increase the melting point of a the film.

Films produced from petrochemical stocks and renewable stocks based films are good for use in wet applications. Generally such films have low VTR and OTR and high melting points. Additives can be added to the films to further reduce the VTR and OTR, and to raise the melting point of these films. In addition, additives can be added to render the films biodegradable and/or compostable. Petrochemical based films can include additives, such as for example, non-toxic metals, which can be mixed into the polymer matrix of the polymer (e.g., a low density polyethylene) to provide sites that bacteria and fungi can attack and degrade the modified polymer. Films derived from renewable non-petrochemical stocks, such as P-hydroxy butyrate, can be used to produced the same polymers and can similarly be modified to assist with biodegradation and compostability of the film.

IV. Types of Articles Produced

In particular embodiments, the containers are suitable for holding hot foods or beverages, such as coffee, hot water, hot chocolate, hamburgers, cheeseburgers, French fries, hot desserts, and the like.

Materials capable of holding dry, damp and wet products have diverse uses. Containers suitable for holding dry materials can be used to hold dried fruit, or raw nuts such as almonds. Containers suitable for holding damp materials can be used to hold fresh mushrooms or tomatoes (for example in groups of 4 or 6) and should be able to perform this function for a period of at least about two to three weeks since normal packing to use time is about 14 days. Damp food packing can also be used with a hot fast food item such as french fries or hamburger, in which case the container needs to last for only a short time, for example about one hour after addition of the damp food. Damp food packing could also be used, in combination with an adsorbent pad, to package raw meat. In this case, the container needs to withstand exposure to the meat for a period of seven days or longer and desirably can stand at least one cycle of freeze and thaw. If possible this package should be able to withstand a microwave signal. When formulated for holding wet foods, the containers will suitably have the ability to hold a hot liquid, such as a bowl of soup, a cup of coffee or other food item for a period of time sufficient to allow consumption before cooling, for example within one hour of purchase. Such containers can also be used to hold a dry product that will be re-hydrated with hot water such as the soup-in-a-cup products.

By way of example, it is possible to manufacture the following exemplary articles: films, bags, containers, including disposable and non-disposable food or beverage containers, cereal boxes, sandwich containers, “clam shell” containers (including, but not limited to, hinged containers used with fast-food sandwiches such as hamburgers), drinking straws, baggies, golf tees, buttons, pens, pencils, rulers, business cards, toys, tools, Halloween masks, building products, frozen food boxes, milk cartons, fruit juice containers, yoghurt containers, beverage carriers (including, but not limited to, wraparound basket-style carriers, and “six pack” ring-style carriers), ice cream cartons, cups, french fry containers, fast food carryout boxes, packaging materials such as wrapping paper, spacing material, flexible packaging such as bags for snack foods, bags with an open end such as grocery bags, bags within cartons such as a dry cereal box, multiwell bags, sacks, wraparound casing, support cards for products which are displayed with a cover (particularly plastic covers disposed over food products such as lunch meats, office products, cosmetics, hardware items, and toys), computer chip boards, support trays for supporting products (such as cookies and candy bars), cans, tape, and wraps (including, but not limited to, freezer wraps, tire wraps, butcher wraps, meat wraps, and sausage wraps); a variety of cartons and boxes such as corrugated boxes, cigar boxes, confectionery boxes, and boxes for cosmetics-, convoluted or spiral wound containers for various products (such as frozen juice concentrate, oatmeal, potato chips, ice cream, salt, detergent, and motor oil), mailing tubes, sheet tubes for rolling materials (such as wrapping paper, cloth materials, paper towels and toilet paper), and sleeves; printed materials and office supplies such as books, magazines, brochures, envelopes, gummed tape, postcards, three-ring binders, book covers, folders, and pencils-, various eating utensils and storage containers such as dishes, lids, straws, cutlery, knives, forks, spoons, bottles, jars, cases, crates, trays, baking trays, bowls, microwaveable dinner trays, “TV” dinner trays, egg cartons, meat packaging platters, disposable plates, vending plates, pie plates, and breakfast plates, emergency emesis receptacles (i.e., “barf bags”), substantially spherical objects, toys, medicine vials, ampoules, animal cages, firework shells, model rocket engine shells, model rockets, coatings, laminates, and an endless variety of other objects.

The container should be capable of holding its contents, whether stationary or in movement or handling, while maintaining its structural integrity and that of the materials contained therein or thereon. This does not mean that the container is required to withstand strong or even minimal external forces. In fact, it can be desirable in some cases for a particular container to be extremely fragile or perishable. The container should, however, be capable of performing the function for which it was intended. The necessary properties can be designed into the material and structure of the container beforehand.

The container should also be capable of containing its goods and maintaining its integrity for a sufficient period of time to satisfy its intended use. It will be appreciated that, under certain circumstances, the container can seal the contents from the external environments, and in other circumstances can merely hold or retain the contents.

The terms “container” or “containers” as used herein, are intended to include any receptacle or vessel utilized for, e.g., packaging, storing, shipping, serving, portioning, or dispensing various types of products or objects (including both solids and liquids), whether such use is intended to be for a short-term or a long-term duration of time.

Containment products used in conjunction with the containers are also intended to be included within the term “containers.” Such products include, for example, lids, straws, interior packaging, such as partitions, liners, anchor pads, corner braces, corner protectors, clearance pads, hinged sheets, trays, funnels, cushioning materials, and other object used in packaging, storing, shipping, portioning, serving, or dispensing an object within a container.

The containers can or can not be classified as being disposable. In some cases, where a stronger, more durable construction is required, the container might be capable of repeated use. On the other hand, the container might be manufactured in such a way so as to be economical for it to be used only once and then discarded. The present containers have a composition such that they can be readily discarded or thrown away in conventional waste landfill areas as an environmentally neutral material.

The articles can have greatly varying thicknesses depending on the particular application for which the article is intended. They can be in one non-limiting embodiment about 1 mm for uses such as in a cup. In contrast, they can be as thick as needed where strength, durability, and or bulk are important considerations. For example, the article can be up to about 10 cm thick or more to act as a specialized packing container or cooler. In one non-limiting embodiment, the thickness for articles is in a range from about 1.5 mm to about 1 cm, or about 2 mm to about 6 mm.

Using a microstructural engineering approach, the present invention can produce a variety of articles, including plates, cups, cartons, and other types of containers and articles having mechanical properties substantially similar or even superior to their counterparts made from conventional materials, such as paper, polystyrene foam, plastic, metal and glass.

The method of the present invention provides basic methodologies which can be utilized with little modification and a basic material from which product items can be produced by tailoring of the additives and additional processing steps employed. The composition in one embodiment contains at least 75%, at least 85% or at least 95% or more of natural or organic-derived materials by weight of the homogenous moldable composition.

### EXAMPLES

Examples A-AA are examples of articles formed from pregelled starch suspensions as described in PCT WO 03/059756, published Jul. 24, 2003 to New Ice Ltd. Examples 1-6 which follow, are examples of filmed articles.

### Example Mixture A

31.5 g of 5% potato starch gel
18 g of dry corn starch
6 g of dry wood flour [60 mesh soft wood]

Test characteristics—the thick stiff mixture was flat molded in a 4″×4″ flat mold at a low pressure (between 2 and 3 psi) to a thickness of 3 mm. The mold temperature was 250° C. 25 grams of the mixture was molded. The test item was both dry and strong after molding. The strength test was 9 (on a scale of 10, with 1=breaks with little resistance and 10=breaks with significant resistance. A styrofoam tray for meat=8 on this scale and a styrofoam burger clamshell box=5). This mixture was to test a thick mixture and was determined that for a complete molded test item the mixture had to pre shaped into a flat rolled sheet about 2″ square.

### Example Mixture B

5 g 5% potato starch gel
19.5 g of 15% corn starch gel
5 g of 80 mesh softwood flour
0.125 g baking powder—[added to elevate the number of open cells in the final structure by introducing a source of carbon dioxide released by heat and water.]

The flat test [2-3 psi and 250° C. mold] item was dry and had a large number of air cells in the cross linked test pad. The strength test was 2 indicating that items molded from this mixture would be used for low breakage packaging, such as shock spacers.

### Example Mixture C

16.3% 3% potato starch gel
5.9% dry corn starch
14% 80 mesh softwood flour
1% dry baking powder
1% glycerol—[added to produce a product that would release from the mold and to produce a smoother surface on the finished product.]

The flat test [2-3 psi and 250° C. mold] item has a stronger strength index of 4, greater than mixture C with the same open cell structure. This mixture will allow for a stronger product, while still retaining the open cell structure for items such as spacers in packing boxes, e.g., dimpled trays to separate layers of apples in a packing box. This item would, as mixture C, provide good shock protection [crush strength].

### Example Mixture D

25% of a 3% potato starch gel
57% of a 15% corn starch gel
17% 80 mesh softwood flour
1% baking powder

To this mixture was added various amounts of natural material fillers in a effort to reduce the cost per item. In this test group powdered calcium carbonate or bentonite clay was added to the potato starch gel before mixing with the corn starch/wood flour mix. At low levels [up to 5% there is no effect on the strength or amount of entrapped air pockets, suggesting that low levels of these two fillers are appropriate]. At higher levels the basic formulation had to be changed to accommodate the chemical and physical changes that the fillers produced.

### Example Mixture E

10 g of a gel mix of 5% potato starch & 20% bentonite clay
6 g of dry corn starch
7 g of 80 mesh softwood flour
1 g glycerol 6 g of water

Test characteristics—the thick stiff mixture was flat molded in a 4″×4″ flat mold at a low pressure [between 2 and 3 psi] to a thickness of 3 mm. The mold temperature was 250° C. 25 g of the mixture was molded. The test item was both dry and strong after molding. The strength test was 7 with a high level of entrained air pockets. This type of product is hard and has a high degree of strength for use as a primary package. The inclusion of the clay produces a product with higher strength, in addition to reducing the unit cost.

### Example F

16.3 g of a 5% potato starch gel
5.9 g of dry corn starch
3.8 g of 80 mesh softwood flour
1 g of glycerol

Test characteristics—the thick mixture was flat molded in a 4″×4″ flat mold at a low pressure [between 2 and 3 psi] to a thickness of 3 mm. The mold temperature was 250° C. 25 g of the mixture was molded. The test item was both dry and strong after molding. The strength test was 8 with a very high level of entrained air pockets.

### Example G

15.1 g of a 5% potato starch gel
9.1 g of dry corn starch
4.3 g of 80 mesh softwood flour
1 g of glycerol

Test characteristics—the somewhat thick mixture was flat molded in a 4″×4″ flat mold at a low pressure (between 2 and 3 psi) to a thickness of 3 mm. The mold temperature was 250° C. 25 grams of the mixture was molded. The test item was both dry and strong after molding. The strength test was 9 with a high level of entrained air pockets. This mixture is the strongest of the basic formula tests using a mixture that was thick. The next test was to use the same basic formula but with additional water to allow the mixture to be injected as a thinner mix.

### Example H

15.1 g of a 5% potato starch gel
9.1 g of dry corn starch
4.3 g of 80 mesh softwood flour
1 g glycerol
4 g of water

Test characteristics—the thinner mixture was flat molded in a 4″×4″ flat mold at a low pressure (between 2 and 3 psi) to a thickness of 3 mm. The mold temperature was 250° C. 25 g of the mixture was molded. The test item was both dry and strong after molding. The strength test was 9 with a high level of entrained air pockets. The addition of more water allowed the product to fill the mold more quickly thereby producing a product with strength similar to styrofoam (2 mm thickness standard production). Three millimeter thick trays were made by molding for various times between 3 and 5 minutes at temperatures between 300 and 375° F. using the following formulations. Satisfactory products were obtained.

### Example I

10.8 g wood flour [6020 grade]
23.2 g corn starch
41.8 g 5% pre-gelled potato starch in water
12 g 20% bentonite clay slurry in water

### Example J

10.8 g of wood flour [6020 grade]
23.2 g corn starch
41.8 g of 7.5% pre-gelled potato starch in water

2 mm thick tray were molded at various times between 45 seconds and 2 minutes at temperatures between 350 and 450° F. using the following formulations. Satisfactory products were obtained.

### Example K

10.8 g wood flour [4025 grade]
23.2 g corn starch
3.3 g potato starch
41.8 g 10% pre-gelled potato starch in water

### Example L

10.8 g wood flour [4025 grade]
23.2 g corn starch
3.1 g potato starch
3.3 g bentonite clay
41.8 g of 10% pre-gelled potato starch in water

These trays (in the above examples) have also been coated with a thin film of food grade polymer and/or food grade paraffin wax A specific aspect of this product is the observation that the addition of components is very important. When the dry ingredients, such as corn starch and wood flour are added to the potato starch gel, without premixing into a homogenous mixture, the product suffers a dramatic reduction in strength and will not spread evenly in the mold, producing open voids and unfilled corners. The observation of specific addition was seen in a dozen or more trial mixtures that used a different order of mixing of components. In addition the surface of the molded product can be rough vs. the smooth surface of sequentially mixed products. More recently the product was tested in a three dimensional mold, using classic compression molding techniques, i.e., heated mold with a constant pressure applied during the process. In these test the requirement for a specific order of mixing was also observed and when this order was not observed the finished product suffered significant problems, including incomplete product spread during the molding process, reduction in smoothness of the molded product and a reduction in strength, as measured by classic penetrometer methods.

### Example M

1. Form pregelled paper potato starch suspension:
57.5 g potato starch: 8.5%
43.2 g recycled paper pulp: 6.3%
575 g water: 85%
   Add components, heat to 60-70° C. (ideal) 65° C. with mixing on high speed with a wire whisk to form gel. Once gelled, it is a stable gel that can be cooled, refrigerated, etc., but not frozen.

2. Premix the following materials:
92.3 g wood flour (aspect ratio 1:4)
132.7 g potato starch
159 g corn starch
   to form homogeneous mixture.

3. Add homogenous mixture of wood and starches with the pregelled paper potato starch, mix with a dough hook mixer on low speed. This mixture is stable and can be cooled, refrigerated, etc., but not frozen.

4. Place mixture into mold (50-55 g) and bake at 195-225° C. (ideal 215° C.) for 60-90 seconds (ideal 75)

5. Coating: Especially like PROTECoaT 6616B by New Coat, Inc, commercial, biodegradable, acrylic based, FDA approved for food

Examples of Articles Formed from Pregelled Paper Starch Suspensions

### Example N

1. Form pregelled paper potato starch suspension:
57.5 g dry potato starch: 8.5%
42.31 g recycled paper pulp: 6.2%
580 g water: 85.3%

Add components in a mixer, heat to 60-70° C. (ideal temp 65° C.) with mixing on low RPM with a wire whisk to form gel. When the paper pulp is dispersed, and as the temperature begins to rise (above 30° C.), the RPM of the mixer is increased until the maximum RPM is reached. The heating continues until the temp reaches 65° C. At this time, the mixture is a homogeneous gel suspension. The heat is turned off and beater heads changed to classic dough hook and speed is lowered to 10% of maximum (KitchenAidg). Alternatively, for smaller batches, see for example, step #2 below, the mixing is done by hand. Once gelled, it is a stable gel that can be cooled, refrigerated, etc., but not frozen.

2. Premix the following materials:
4.8 g wood flour (aspect ratio 1:4 or less)
6.9 g potato starch
8.3 g corn starch
   to form homogeneous mixture

3. Add homogenous mixture of wood and starches to 29.9 g of the pregelled paper potato starch, mix with a dough hook mixer on low speed. This mixture is stable and can be cooled or refrigerated, but not frozen.

4. Place mixture into mold (50-55 g) and bake at 195-225° C. (ideal 215° C.) for 60-90 seconds (ideal 75° C.)

5. Coating: Especially like PROTECoaT 6616B by New Coat, Inc, commercial, biodegradable, acrylic based, FDA approved for food.

The following examples and formulas work with both the compression molding process and injection molding processes to produce strong products as measured by pentrometers. In addition, these examples and formulas produce products with thicknesses between 1.5 and 3.0 mm, for example, thicknesses of 1.5 mm, 1.75 mm, 2.0 mm or 3.0 mm.

Weight in grams mixed
by Formula ID #

| List of Ingredients | O | P | Q | R |
|---|---|---|---|---|
| 4025 wood flour | 4.8 | 4.8 | 4.5 | 5.0 |
| Potato starch | 6.9 | 5.9 | 6.5 | 7.2 |
| Corn starch | 8.3 | 9.3 | 7.8 | 8.6 |
| paper pulp | 2.2 | 2.2 | 2.1 | 2.3 |
| 10% potato starch gel | 29.9 | 29.9 | 31 | 28.9 |
| Total wt. molded | 52.1 | 52.1 | 51.9 | 52.0 |

Each modification listed in the above table is based on what works best for a specific flexibility and/or method of molding. For example, as you change the concentration of potato starch, the flexibility will change.

Weight in grams mixed
by Formula ID #

| List of Ingredients | S | T |
|---|---|---|
| 4025 wood flour | 6.7 | 4.8 |
| Potato starch | 9.6 | 6.9 |
| Corn starch | 11.6 | 8.3 |
| paper pulp | 3.1 | 2.2 |
| 10% Potato starch gel | 41.8 | 29.9 |
| Total wt. Molded | 72.8 | 52.0 |
| Thickness of Mold | 3 mm | 2 mm |
| | (deeper | |
| | sides than | |
| | #T) | |

| | Weight in grams mixed | | |
|---|---|---|---|
| | by Formula ID # | | |
| List of Ingredients | U-1 | U-2 | U-3 |
| 4025 wood flour | 3.3 | 5.6 | 3.5 |
| Potato starch | 6.2 | 10.5 | 6.6 |
| Corn starch | 6.1 | 10.3 | 6.5 |
| paper pulp | 1.8 | 3.0 | 1.9 |
| 10% Potato starch gel | 27.6 | 46.6 | 29.4 |
| Total wt. Molded | 45 | 76.0 | 48 |
| Thickness of Mold | 2 mm | 3 mm | 2 mm |
| | Weight in grams mixed | | |
| | by Formula ID # | | |
| List of Ingredients | V-1 | V-2 | V-3 |
| 4025 wood flour | 4.8 | 8.2 | 5.4 |
| Potato starch | 6.9 | 11.8 | 7.8 |
| Corn starch | | | |
| paper pulp | 1.8 | 3.1 | 2.0 |
| 10% Potato starch gel | 29.9 | 51.0 | 33.8 |
| Total wt. Molded | 43.4 | 74.0 | 49 |
| Thickness of Mold | 2 mm | 3 mm | 2 mm |

Weight in grams mixed
by Formula ID #

| List of Ingredients | W-1 | W-2 |
|---|---|---|
| 4025 wood flour | 3.8 | 6.3 |
| Potato starch | 6.9 | 11.5 |
| Corn starch | 2 | 3.3 |
| paper pulp | 1.8 | 3.0 |
| 10% Potato starch gel | 29.8 | 49.8 |
| Total wt. Molded | 44.4 | 74.0 |
| Thickness of Mold | 2 mm | 3 mm |

Examples of Articles Formed from Pregelled Paper-Waxy Potato Starch Suspensions

The following examples include a “virgin” cellulose pulp, rather than wood flour and paper pulp employed in the prior examples. The virgin cellulose pulp is provided in large blocks of compressed pulp and is derived from managed forests. The material is bleached and is ready to be used as provided. The virgin cellulose pulp has an aspect ration of less than 1:10, preferably less than 1:9, more preferably less than 1:8. In addition, the following examples include a waxy potato starch source which is made up of approximately 100% amylopectin potato starch. Additionally, the examples include food grade magnesium stearate and a foaming agent.

Examples are as follows:

### Example Mixture X [100% Waxy Potato Starch]

1. Form a pregelled cellulose paper-waxy potato starch suspension.
5.8 g waxy potato starch [Eliane 100]: 8.3%
6.5 g virgin cellulose pulp: 9.2%
58 g Water: 82.5%
   Add components, heat to 60-70° C. with mixing on high speed with a wire wisk to form the gel. Alternatively, as the paper pulp is dispersed, and as the temperature begins to rise (above 30° C.), the RPM of the mixer is increased until the maximum RPM is reached. The heating continues until the temp reaches 65° C. At this time, the mixture is a homogeneous gel suspension. The heat is turned off and beater heads changed to classic dough hook and speed is lowered to 10% of maximum (KitchenAid®). Once gelled, the gel may be cooled or refrigerated (but not frozen) until used.

2. Premix the following materials:
32.2 g waxy potato starch [Eliane 100]
0.25 g magnesium stearate
0.05 g foaming agent

3. Add homogenous mixture of wood and starches to 29.9 g of the pregelled paper potato starch, mix with a dough hook mixer on low speed. This mixture is stable and can be cooled or refrigerated, but not frozen.

4. Place mixture into mold (about 50-55 g) and bake at 195-225° C. (ideal 215° C.) for 60-90 seconds (ideal 75° C.)

Example X is preferably used for flatter trays.

### Example Mixture Y [90% Waxy Potato+10 Corn Starch]

1. Form a pregelled cellulose paper-waxy potato starch suspension.
5.8 g waxy potato starch [Eliane 100]: 8.3%
6.5 g virgin cellulose pulp: 9.2%
58 g water: 82.5%

2. Premix the following materials:
29 g waxy potato starch [Eliane 100]
3.2 g corn starch
0.125 g magnesium stearate
0.025 g foaming agent

3. Add homogenous mixture of wood and starches to 29.9 g of the pregelled paper potato starch, mix with a dough hook mixer on low speed. This mixture is stable and can be cooled or refrigerated, but not frozen.

4. Place mixture into mold (about 50-55 g) and bake at 195-225° C. (ideal 215° C.) for 60-90 seconds (ideal 75° C.)

Example Y is preferably used for deeper trays that require high edge strength.

### Example Z [80% Waxy Potato+20% Corn Starch]

1. Form a pregelled cellulose paper-waxy potato starch suspension.
5.8 g waxy potato starch [Eliane 100]: 8.3%
6.5 g virgin cellulose pulp: 9.2%
58 g water: 82.5%

2. Premix the following materials:
22.5 g waxy potato starch [Eliane 100]
9.7 g corn starch
0.125 g magnesium stearate
0.025 g foaming agent

3. Add homogenous mixture of wood and starches to 29.9 g of the pregelled paper potato starch, mix with a dough hook mixer on low speed. This mixture is stable and can be cooled or refrigerated, but not frozen.

4. Place mixture into mold (about 50-55 g) and bake at 195-225° C. (ideal 215° C.) for 60-90 seconds (ideal 75° C.)

Example Z is preferably used for trays that need to be over wrapped or edge sealed.

### Example AA [70% Waxy Potato+30% Corn Starch]

1. Form a pregelled cellulose paper-waxy potato starch suspension.
5.8 g waxy potato starch [Eliane 100]: 8.3%
6.5 g virgin cellulose pulp: 9.2%
58 g water: 82.5%

2. Premix the following materials:
29 g waxy potato starch [Eliane 100]
0.125 g magnesium stearate
0.025 g foaming agent

3. Add homogenous mixture of wood and starches to 29.9 g of the pregelled paper potato starch, mix with a dough hook mixer on low speed. This mixture is stable and can be cooled or refrigerated, but not frozen.

4. Place mixture into mold (about 50-55 g) and bake at 195-225° C. (ideal 215° C.) for 60-90 seconds (ideal 75° C.)

Example AA is preferably used for deeper trays or salad/soup type bowls requiring high edge strength.

### Examples of Filming

### Example 1

A sheet of blow molded film, such as Ecoflex 1340, with a melt point between 145 and 170° C. is cut to fit the holder of a traditional vacuum forming machine. The container is heated in an oven to a temperature within the melt range, to simulate a temperature that is consistent with that of the actual manufacturing process. The container is transferred to the nest within the vacuum machine and the film holder closed over the container. Using the flash heater of the forming unit the film is quickly heated to a temperature just above the melt point of the specific film. The time to flash heat the film is dependent on the given type of heating system and the construction of any specific filming unit. A vacuum is applied and the softened film is drawn into the container. The film and container are allowed to cool to a temperature below the melt point, the filmed container is removed and any excess film and/or rough edges of the container are trimmed, by classic methods, to its final size.

### Example 2

A 1.75 mil biodegradable and compostable BASF film, such as Ecoflex 1340, is cut and placed into the holder. The container is heated to a temperature of 150 to 175° C. and placed in the nest. The film is surface heated to a temperature of 145 to 160° C. within 15 seconds and the vacuum applied to pull the film into the container and the system is cooled.

### Example 3

A 1.75 mil biodegradable and compostable BASF film, such as Ecoflex 1340, is cut and placed into the holder. The container is heated to a temperature of 175° C. and placed in the nest. The film is surface heated to a temperature of 155° C. within 12 seconds and the vacuum applied to pull the film into the container and the system is cooled.

### Example 4

A 1.75 mil film heated to 165° C. within 10 seconds, container heated to 175° C.

### Example 5

A 5 mil film heated to 165° C. within 16 seconds, container heated to 175° C.

### Example 6

A 10 mil film heated 165° C. within 20 seconds, container heated to 175° C.

The invention has been described with reference to various specific and preferred embodiments and techniques. However, it should be understood that many variations and modifications will be obvious to those skilled in the art from the foregoing detailed description of the invention and may be made while remaining within the spirit and scope of the invention.

What is claimed is:

1. A method for filming a biodegradable container, comprising:
(a) providing a heated biodegradable container, wherein the temperature of the container is approximately the melt temperature of a biodegradable film;
(b) heating the biodegradable film; and
(c) applying the heated biodegradable film to the surface of the container.

2. The method of claim 1, wherein the temperature of the container is between about 70 and about 200° C.

3. The method of claim 2, wherein the temperature of the container is between about 120 and about 190° C.

4. The method of claim 2, wherein the temperature of the container is between about 145 and about 170° C.

5. The method of claim 1, wherein the film comprises a polyester, a polyolefin, a polyacetic acid, a polyethylene or copolymers thereof.

6. The method of claim 1, wherein the film comprises an aliphatic aromatic copolyester.

7. The method of claim 1, wherein the film comprises polyethylene.

8. The method of claim 1 wherein the film has a melt temperature of between about 120 and about 200° C.

9. The method of claim 1, wherein the film has a melt temperature of between about 145 and about 170° C.

10. The method of claim 1, further comprising applying an adhesive between the container and the film.

11. The method of claim 1, wherein the biodegradable film is applied in liquid form.

12. The method of claim 11, wherein the film is applied to the container by spray coating, dip coating or by painting.

13. The method of claim 1, wherein the biodegradable film is applied in solid form.

14. The method of claim 13, wherein the film is applied to the container by vacuum.

15. The method of claim 1, wherein the film thickness is between about 0.25 and about 15 mil.

16. The method of claim 1, wherein the film thickness is between about 0.5 and about 2.0 mil.

17. The method of claim 1, wherein the film has a vapor transfer rate of less than 200 g H₂0/100 in² per 24 hours.

18. The method of claim 1, wherein the film has a vapor transfer rate of less than 5 g H₂0/100 in² per 24 hours.

19. A method for filming a biodegradable container comprising:
(a) provided a starch-based biodegradable container which has been heated to a temperature approximately equal to the melt temperature of a biodegradable film;
(b) heating the biodegradable film;
(c) applying the heated biodegradable film to the surface of the container.

20. The method of claim 19, wherein the container is formed from a pre-gelled starch suspension that is maintained at low temperatures.

21. The method of claim 19, wherein the pre-gelled starch is formed from a native or modified starch.

22. The method of claim 21, wherein the native starch is potato or corn starch.

23. The method of claim 21, wherein the modified starch is a waxy potato starch.

24. The method of claim 21, wherein pre-gelled starch suspension further comprises cellulose pulp.

25. A filmed biodegradable container made according to a process of any one of claims 1 or 19.

26. The container of claim 25, which disintegrates to its component parts in less than one year.

27. The container of claim 25, which disintegrates to its component parts in less than six months.

28. The container of claim 25, which disintegrates in approximately 24 days.

29. The container of claim 25, in the form of an article selected from the group consisting of a cup, a tray, a bowl, a plate, a utensil, a coffee cup, a microwave dinner tray and a television dinner tray.
